(19) United States
(12) Patent Application Publication
(10) Pub. No.: US 2014/0068487 A1
(43) Pub. Date: Mar. 6, 2014

(54) Computer Implemented Methods For Visualizing Correlations Between Blood Glucose Data And Events And Apparatuses Thereof

(71) Applicants: Bernd Steiger, Roemerberg (DE); Ralf Schmitz, Weinheim (DE)

(72) Inventors: Bernd Steiger, Roemerberg (DE); Ralf Schmitz, Weinheim (DE)

(73) Assignee: ROCHE DIAGNOSTICS OPERATIONS, INC., Indianapolis, IN (US)

(21) Appl. No.: 13/603,853

(22) Filed: Sep. 5, 2012

(51) Int. Cl. G06F 3/0481

(52) U.S. Cl. CPC G06F 3/0481
USPC 715/771

(57) ABSTRACT

Methods and apparatuses for visualizing correlations between blood glucose data and events are disclosed. The methods and apparatus can include presenting an event analysis window on a display communicatively coupled to one or more processors. The event analysis window can include an event type control positioned within the event analysis window and a graphical window positioned within the event analysis window. A plurality of continuous glucose monitoring traces can be plotted within the graphical window. Bolus icons each indicative of a bolus amount and a bolus time can be presented within the event analysis window. Each of the bolus icons can include a bolus indication object that is aligned with the bolus ordinate axis within the graphical window, a bolus time indication object that is aligned with the time abscissa axis within in the graphical window, and a bolus symbol that is presented outside of the graphical window.

### TECHNICAL FIELD

Embodiments of the present invention relate generally to methods and apparatuses for analyzing blood glucose data and events, and particularly to computer implemented methods for visualizing correlations between blood glucose data and events associated with the blood glucose data and apparatuses thereof.

### BACKGROUND

A disease which is long lasting or which reoccurs often is defined typically as a chronic disease. Known chronic diseases include, among others, depression, compulsive obsession disorder, alcoholism, asthma, autoimmune diseases (e.g. ulcerative colitis, lupus erythematosus), osteoporosis, cancer, and diabetes mellitus. Such chronic diseases require chronic care management for effective long-term treatment. After an initial diagnosis, one of the functions of chronic care management is then to optimize a patient's therapy of the chronic disease.

In the example of diabetes mellitus, which is characterized by hyperglycemia resulting from inadequate insulin secretion, insulin action, or both, it is known that diabetes manifests itself differently in each person because of each person's unique physiology that interacts with variable health and lifestyle factors such as diet, weight, stress, illness, sleep, exercise, and medication intake. Biomarkers are patient biologically derived indicators of biological or pathogenic processes, pharmacologic responses, events or conditions (e.g., aging, disease or illness risk, presence or progression, etc.). For example, a biomarker can be an objective measurement of a variable related to a disease, which may serve as an indicator or predictor of that disease. In the case of diabetes mellitus, such biomarkers include measured values for glucose, lipids, triglycerides, and the like. A biomarker can also be a set of parameters from which to infer the presence or risk of a disease, rather than a measured value of the disease itself. When properly collected and evaluated, biomarkers can provide useful information related to a medical question about the patient, as well as be used as part of a medical assessment, as a medical control, and/or for medical optimization.

For diabetes, clinicians generally treat diabetic patients according to published therapeutic guidelines such as, for example, Joslin Diabetes Center & Joslin Clinic, Clinical Guideline for Pharmacological Management of Type 2 Diabetes (2007) and Joslin Diabetes Center & Joslin Clinic, Clinical Guideline for Adults with Diabetes (2008). The guidelines may specify a desired biomarker value, e.g., a fasting blood glucose value of less than 100 mg/dl, or the clinician can specify a desired biomarker value based on the clinician's training and experience in treating patients with diabetes.

Accordingly, when following such guidelines, a patient with a chronic disease may be asked by different clinicians at various times to perform a number of collections in an effort to diagnose a chronic disease or to optimize therapy. For example, diabetic patients may measure their glucose levels concurrently with various events that occur according to the patient's lifestyle. The events may or may not be correlated with or influence biomarkers of the chronic disease or the optimization of therapy. However, the correlations between the events and the biomarkers can be difficult to identify. Moreover, prior art collection devices fail to facilitate the visualization of the correlations between the events and the biomarkers either through lack of functionality or by requiring complex interactions.

### SUMMARY

It is against the above background that the embodiments described herein present computer-implemented methods and graphical user interfaces for visualizing correlations between blood glucose data and events. The present embodiments can be implemented on any system or device including one or more processors, such as a blood glucose measuring device.

In one embodiment, computer-implemented method for visualizing correlations between blood glucose data and events can include presenting by one or more processors automatically an event analysis window on a display communicatively coupled to the one or more processors. The event analysis window can include an event type control positioned within the event analysis window and a graphical window positioned within the event analysis window. The graphical window can include a time abscissa axis that defines time units within the graphical window, a glucose ordinate axis that defines glucose units within the graphical window, and a bolus ordinate axis that defines bolus units within the graphical window. Event selection input can be received via the event type control. The event selection input can be indicative of an event type associated with a plurality of event instances each being associated with an event time. A reference time can be defined along the time abscissa axis of the graphical window. A plurality of blood glucose values associated with a monitoring time period can be segmented into a plurality of continuous glucose monitoring traces each indicative of blood glucose values by the one or more processors automatically. Each of the plurality of continuous glucose can span a time segment of the monitoring time period such that the time segment is coincident with the event time of one of the plurality of event instances. The plurality of continuous glucose monitoring traces can be plotted within the graphical window automatically by the one or more processors. The plurality of continuous glucose monitoring traces can be scaled according to the glucose ordinate axis and the time abscissa axis by the one or more processors automatically, and the time segment is normalized to and aligned with the reference time by the one or more processors automatically. A plurality of bolus icons each indicative of a bolus amount and a bolus time that is coincident with the monitoring time period of one of the plurality of continuous glucose monitoring traces can be presented within the event analysis window automatically by the one or more processors. Each of the plurality of bolus icons can include a bolus indication object that is aligned with the bolus ordinate axis within the graphical window by one or more processors automatically, a bolus time indication object that is aligned with the time abscissa axis within in the graphical window by one or more processors automatically, and a bolus symbol that is presented outside of the graphical window by one or more processors automatically.

In another embodiment, a non-transitory computer readable medium storing a program causing one or more processors communicatively coupled to a display to execute a graphical user interface process for visualizing correlations between blood glucose data and events is disclosed. The graphical user interface process may comprise presenting by the one or more processors automatically an event analysis window on the display, the event analysis window comprising an event type control positioned within the event analysis window and an graphical window positioned within the event analysis window, wherein the graphical window comprises a time abscissa axis that defines time units within the graphical window, a glucose ordinate axis that defines glucose units within the graphical window, and a bolus ordinate axis that defines bolus units within the graphical window. The process may comprise receiving by the one or more processors event selection input via the event type control, wherein the event selection input is indicative of an event type associated with a plurality of event instances each being associated with an event time, defining a reference time along the time abscissa axis of the graphical window, and segmenting by the one or more processors automatically a plurality of blood glucose values associated with a monitoring time period into a plurality of continuous glucose monitoring traces each indicative of blood glucose values, wherein each of the plurality of continuous glucose monitoring traces span a time segment of the monitoring time period such that the time segment is coincident with the event time of one of the plurality of event instances. The process may comprise plotting by the one or more processors automatically the plurality of continuous glucose monitoring traces within the graphical window, wherein the plurality of continuous glucose monitoring traces are scaled according to the glucose ordinate axis and the time abscissa axis, and the time segment is normalized to and aligned with the reference time. The process may comprise presenting by the one or more processors automatically, within the event analysis window, a plurality of bolus icons each indicative of a bolus amount and a bolus time that is coincident with the monitoring time period of one of the plurality of continuous glucose monitoring traces, wherein each of plurality of bolus icons comprises a bolus indication object that is aligned with the bolus ordinate axis within the graphical window, a bolus time indication object that is aligned with the time abscissa axis within in the graphical window, and a bolus symbol that is presented outside of the graphical window.

In still another embodiment, a medical device is disclosed that comprises a display and one or more processors communicatively coupled to the display and which is configured to present automatically an event analysis window on the display, the event analysis window comprising an event type control positioned within the event analysis window and an graphical window positioned within the event analysis window, wherein the graphical window comprises a time abscissa axis that defines time units within the graphical window, a glucose ordinate axis that defines glucose units within the graphical window, and a bolus ordinate axis that defines bolus units within the graphical window. The one or more processor may be configured to receive event selection input via the event type control, wherein the event selection input is indicative of an event type associated with a plurality of event instances each being associated with an event time, and define a reference time along the time abscissa axis of the graphical window. The one or more processor may be configured to segment automatically a plurality of blood glucose values associated with a monitoring time period into a plurality of continuous glucose monitoring traces each indicative of blood glucose values, wherein each of the plurality of continuous glucose monitoring traces span a time segment of the monitoring time period such that the time segment is coincident with the event time of one of the plurality of event instances. The one or more processor may be configured to plot automatically the plurality of continuous glucose monitoring traces within the graphical window, wherein the plurality of continuous glucose monitoring traces are scaled according to the glucose ordinate axis and the time abscissa axis, and the time segment is normalized to and aligned with the reference time. The one or more processor may be configured to present automatically, within the event analysis window, a plurality of bolus icons each indicative of a bolus amount and a bolus time that is coincident with the monitoring time period of one of the plurality of continuous glucose monitoring traces, wherein each of plurality of bolus icons comprises a bolus indication object that is aligned with the bolus ordinate axis within the graphical window, a bolus time indication object that is aligned with the time abscissa axis within in the graphical window, and a bolus symbol that is presented outside of the graphical window.

These and other advantages and features of the invention disclosed herein, will be made more apparent from the description, drawings and claims that follow.

### BRIEF DESCRIPTION OF THE DRAWINGS

The following detailed description of the embodiments of the present disclosure can be best understood when read in conjunction with the following drawings, where like structure is indicated with like reference numerals.

FIG. 1 schematically depicts a chronic care management system for a diabetes patient and a clinician along with others having an interest in the chronic care management of the patient according to one or more embodiments described herein.

FIG. 2 schematically depicts a system suitable for implementing a computer-implemented method or graphical user interface according to one or more embodiments described herein.

FIG. 3 schematically depicts a collection device for collecting biomarkers according to one or more embodiments described herein.

FIG. 4 schematically depicts an event analysis window according to one or more embodiments described herein.

FIGS. 4A and 4B schematically depict icons according to one or more embodiments described herein.

FIGS. 5 and 6 schematically depict an event analysis window according to one or more embodiments described herein.

FIGS. 7 and 8 schematically depict methods for visualizing correlations between blood glucose data and events according to one or more embodiments described herein.

FIGS. 9-13 schematically depict an event analysis window of a graphical user interface according to one or more embodiments described herein.

FIG. 14 schematically depicts another event analysis window of a graphical user interface according to one or more embodiments described herein.

### DETAILED DESCRIPTION

The present disclosure may be implemented in a number of different applications and embodiments and is not specifically limited in its application to the particular embodiments depicted herein. In particular, the embodiments described herein are provided below in connection with diabetes management via sampling blood. However, it is noted that the embodiments described herein can be modified to be used with other types of fluids or analytes besides glucose, and/or useful in managing other chronic diseases besides diabetes.

As used herein with the various illustrated embodiments described below, the following terms include, but are not limited to, the following meanings.

The term “biomarker” can mean a physiological variable measured to provide data relevant to a patient such as for example, a blood glucose value, an interstitial glucose value, an HbAlc value, a heart rate measurement, a blood pressure measurement, lipids, triglycerides, cholesterol, and the like.

The term “signal” can mean a waveform (e.g., electrical, optical, magnetic, mechanical or electromagnetic), such as DC, AC, sinusoidal-wave, triangular-wave, square-wave, vibration, and the like, capable of traveling through a medium.

The phrase “communicatively coupled” can mean that components are capable of exchanging data signals with one another such as, for example, electrical signals via conductive medium, electromagnetic signals via air, optical signals via optical waveguides, and the like.

The term “sensor” can mean a device that measures a physical quantity and converts it into a data signal, which is correlated to the measured value of the physical quantity, such as, for example, an electrical signal, an electromagnetic signal, an optical signal, a mechanical signal, and the like.

The term “continuous” can mean substantially uninterrupted for a period of time. Accordingly, continuous data can be data that is sampled in a substantially uninterrupted manner for a period of time, i.e., the data can be sampled at a set and/or varying sample rate with minimal interruption.

The term “event” can mean a parameter that occurs at a particular time and/or a particular range of time that can be correlated with or influence biomarkers such as, for example, exercise, ingestion of medication, stress, illness, hypoglycemia, hyperglycemia, change in blood glucose level, sleep, fasting, spot bG measurements, consumption of food, or any other occurrence that describes lifestyle.

The term “control” can mean a visual element that provides information and a point of interaction between an interaction element and/or a user interface device and the software such as, for example, a button, a check box, a radio button, a split button, slider, list box, a spinner, a drop-down list, a menu or the like.

The term “associated” can mean that data, controls, or processes are referenced to additional data, controls, or processes such that one or more processers can automatically follow the reference to access the additional data, controls, or processes.

The terms “software” and “program” may be used herein interchangeably.

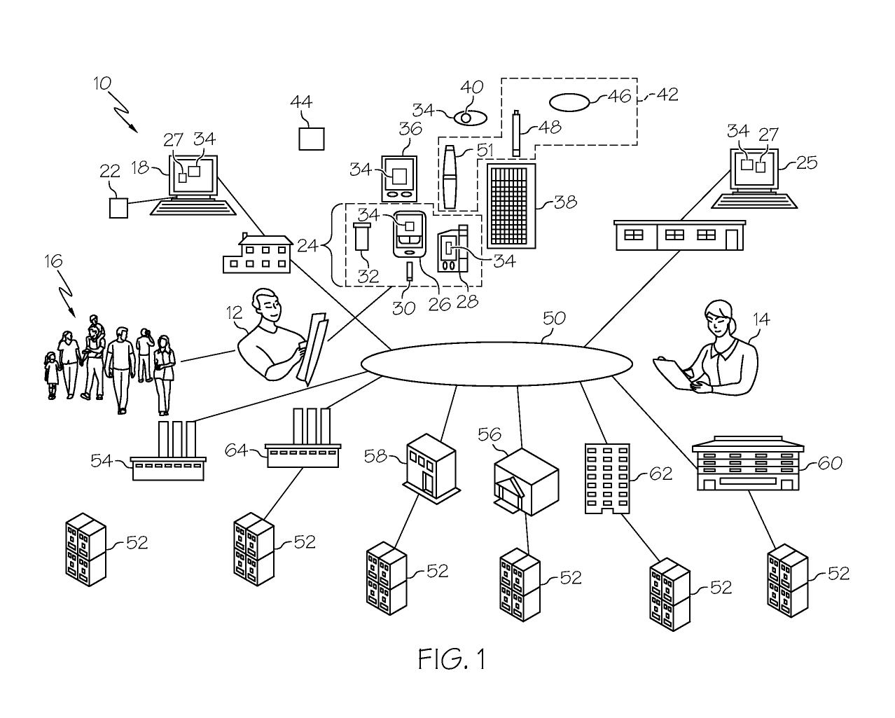

FIG. 1 shows a chronic care management system 10 for a diabetes patient(s) 12 and a clinician(s) 14 along with others 16 having an interest in the chronic care management of the patient 12. Patient 12, having dysglycemia, may include persons with a metabolic syndrome, pre-diabetes, type 1 diabetes, type 2 diabetes, and gestational diabetes. The others 16 with an interest in the patient's care may include family members, friends, support groups, and religious organizations all of which can influence the patient's conformance with therapy. The patient 12 may have access to a patient computer 18, such as a home computer, which can connect to a public network 50 (wired or wireless), such as the internet, cellular network, etc., and couple to a dongle, docking station, or device reader 22 for communicating with an external portable device, such as a portable collection device 24. An example of a device reader is shown in the manual “Accu-Chek® Smart Pix Device Reader User's Manual” (2008) available from Roche Diagnostics.

The collection device 24 can be essentially any portable electronic device that can function as an acquisition mechanism for determining and storing digitally a biomarker value(s) according to a structured collection procedure, and which can function to run a structured collection procedure or any other method for collecting biomarker values. In one embodiment, the collection device 24 can be a self-monitoring blood glucose meter 26 or a continuous glucose monitor 28. An example of a blood glucose meter is the Accu-Chek® Active meter, and the Accu-Chek® Aviva meter described in the booklet “Accu-Chek® Aviva Blood Glucose Meter Owner's Booklet (2007), portions of which are disclosed in U.S. Pat. No. 6,645,368 B1 entitled “Meter and method of using the meter for determining the concentration of a component of a fluid” assigned to Roche Diagnostics Operations, Inc., which is hereby incorporated by reference. An example of a continuous glucose monitor is shown in U.S. Pat. No. 7,389,133 “Method and device for continuous monitoring of the concentration of an analyte” (Jun. 17, 2008) assigned to Roche Diagnostics Operations, Inc., which is hereby incorporated by reference.

In addition to the collection device 24, the patient 12 can use a variety of products to manage his or her diabetes including: test strips 30 carried in a vial 32 for use in the collection device 24; software 34 which can operate on the patient computer 18, the collection device 24, a handheld computing device 36, such as a laptop computer, a personal digital assistant, and/or a mobile phone; and paper tools 38. Software 34 can be pre-loaded or provided either via a computer readable medium 40 or over the public network 50 and loaded for operation on the patient computer 18, the collection device 24, the clinician computer/office workstation 25, and the handheld computing device 36, if desired. In still other embodiments, the software 34 can also be integrated into the device reader 22 that is coupled to the computer (e.g., computers 18 or 25) for operation thereon, or accessed remotely through the public network 50, such as from a server 52.

The patient 12 can also use, for certain diabetes therapies, additional therapy devices 42 and other devices 44. Therapy devices 42 can include devices such as an ambulatory infusion pump 46, an insulin pen 48, and a lancing device 51. An example of an ambulatory insulin pump 46 include but not limited thereto the Accu-Chek® Spirit pump described in the manual “Accu-Chek® Spirit Insulin Pump System Pump User Guide” (2007) available from Roche Diabetes Care. The other devices 44 can be medical devices that provide patient data such as blood pressure, fitness devices that provide patient data such as exercise information, and elder care device that provide notification to care givers. The other devices 44 can be configured to communicate with each other according to standards planned by Continua® Health Alliance.

The clinicians 14 for diabetes are diverse and can include, for example, nurses, nurse practitioners, physicians, endocrinologists, and other such health care providers. The clinician 14 typically has access to a clinician computer 25, such as a clinician office computer, which can also be provided with the software 34. A healthcare record system 27, such as Microsoft® HealthVault™ and Google™ Health, may also be used by the patient 12 and the clinician 14 on computers 18, 25 to exchange information via the public network 50 or via other network means (LANs, WANs, VPNs, etc.), and to store information such as collection data from the collection device 24 to an electronic medical record of the patient e.g., EMR which can be provided to and from computer 18, 25 and/or server 52.

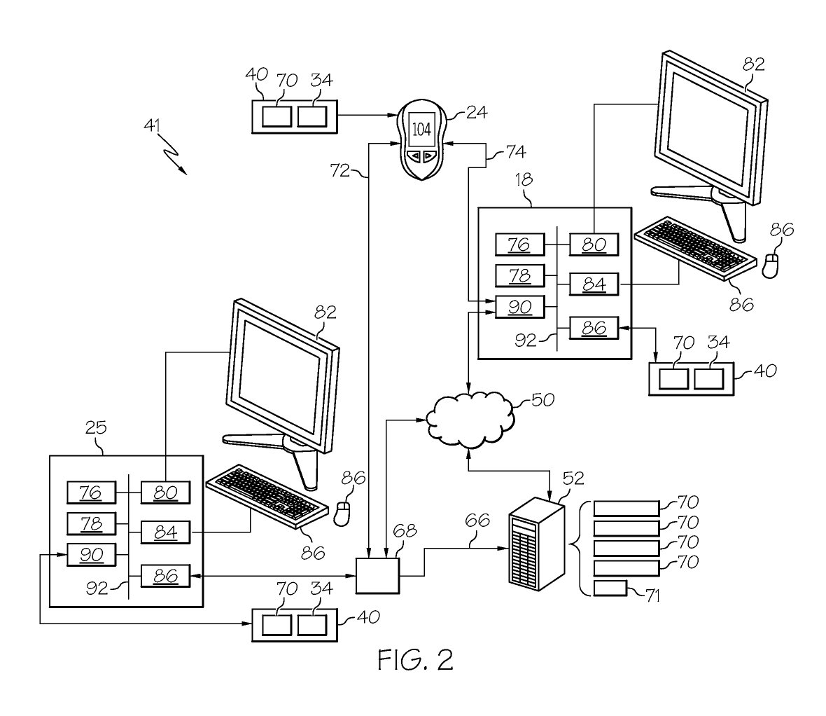

Most patients 12 and clinicians 14 can interact over the public network 50 with each other and with others having computers/servers 52. Such others can include the patient's employer 54, a third party payer 56, such as an insurance company who pays some or all of the patient's healthcare expenses, a pharmacy 58 that dispenses certain diabetic consumable items, a hospital 60, a government agency 62, which can also be a payer, and companies 64 providing healthcare products and services for detection, prevention, diagnosis and treatment of diseases. The patient 12 can also grant permissions to access the patient's electronic health record to others, such as the employer 54, the payer 56, the pharmacy 58, the hospital 60, and the government agencies 62 via the healthcare record system 27, which can reside on the clinician computer 25 and/or one or more servers 52. Reference hereafter is also made to FIG. 2.

FIG. 2 shows a system 41 suitable for implementing embodiments of the methods described herein, which in another embodiment can be a part of the chronic care management system 10 and communicate with such components, via conventional wired or wireless communication means. The system 41 can include the clinician computer 25 that is in communication with a server 52 as well as the collection device 24. Communications between the clinician computer 25 and the server 52 can be facilitated via a communication link to the public network 50, to a private network 66, or combinations thereof. The private network 66 can be a local area network or a wide are network (wired or wireless) connecting to the public network 50 via a network device 68 such as a (web) server, router, modem, hub, and the like.

In one embodiment, the server 52, as well as the network device 68, can function also as a data aggregator for collected biomarker data 70. Accordingly, in such an embodiment, the biomarker data 70 of a completed collection procedure(s) from a collection device of the patient 12 can then be provided from the server 52 and/or network device 68 to the clinician computer 25 when requested in response to a retrieval for such patient data.

In one embodiment, one or more of a plurality of instances of biomarker data 70 aggregated on the server 52 can be provided over the public network 50, such as through a secure web interface implemented on the patient computer 18, the clinician computer 25, and/or the collection device 24. In another embodiment, the clinician computer 25 can serve as the interface (wired or wireless) 72 between the server 52 and the collection device 24. In still another embodiment, biomarker data 70, as well as software 34, may be provided on a computer readable medium 40 and loaded directly on the patient computer 18, the clinician computer 25, and/or the collection device 24. In still another embodiment, biomarker data 70 and software 34 may be sent between the patient computer 18, the clinician computer 25, the server 52 and/or the collection device 24 via the public network 50, the private network 66, via a direct device connection (wired or wireless) 74, or combinations thereof. Accordingly, in one embodiment the external devices e.g., computer 18 and 25, can be used to establish a communication link 72, 74 between the collection device 24 and still further electronic devices such as other remote Personal Computer (PC), and/or servers such as through the public network 50, such as the Internet and/or other communication networks (e.g., LANs, WANs, VPNs, etc.), such as private network 66.

The patient computer 18, as a conventional personal computer/workstation, can include a processor 76 which executes programs, such as software 34, and such as from memory 78 and/or computer readable medium 40. Memory 78 can include system memory (RAM, ROM, EEPROM, etc.), and storage memory, such as hard drives and/or flash memory (internal or external). The patient computer 18 can also include a graphics processor 80 (e.g., to interface a display 82 with the processor 76, input/output connections 84 for connecting user interface devices 86, such as a keyboard and mouse (wired or wireless), and computer readable drives 88 for portable memory and discs, such as computer readable medium 40. The patient computer 18 can further include communication interfaces 90 for connections to the public network 50 and other devices, such as collection device 24 (wired or wireless), and a bus interface 92 for connecting the above mentioned electronic components to the processor 76.

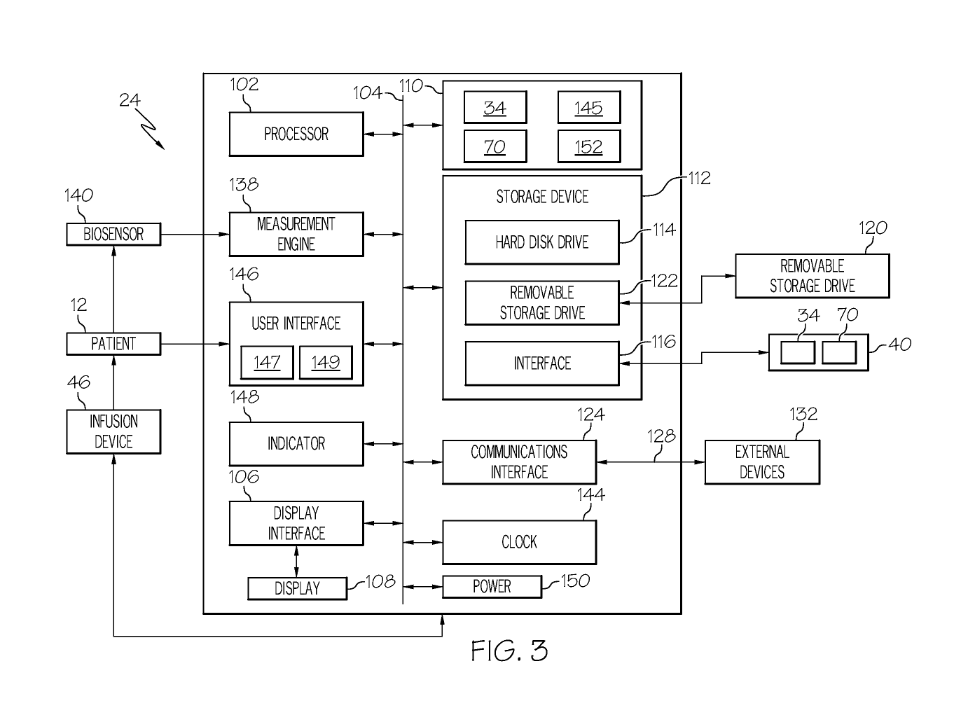

Similarly, the clinician computer 25, as a conventional personal computer/workstation, can include a processor 76 which executes programs, such as software 34, and such as from memory 78 and/or computer readable medium 40. The clinician computer 25 can also include a graphics processor 80 to interface a display 82 with the processor 76, input/output connections 84 for connecting user interface devices 86, such as a keyboard and mouse (wired or wireless), and computer readable drives 88 for portable memory and discs, such as computer readable medium 40. The clinician computer 25 can further include communication interfaces 90 for connections to the public network 50 and other devices, such as collection device 24 (wired or wireless), and a bus interface 92 for connecting the above mentioned electronic components to the processor 76. Reference hereafter is now made to FIG. 3.

FIG. 3 is a block diagram conceptually illustrating the portable collection device 24 depicted in FIG. 2. In the illustrated embodiment, the collection device 24 can include one or more microprocessors, such as processor 102, which may be a central processing unit comprising at least one more single or multi-core and cache memory, which can be connected to a bus 104, which may include data, memory, control and/or address buses. The collection device 24 can include the software 34, which provides instruction codes that causes a processor 102 of the device to implement the methods provided herein. The collection device 24 may include a display interface 106 providing graphics, text, and other data from the bus 104 (or from a frame buffer not shown) for display on a display 108. The display interface 106 may be a display driver of an integrated graphics solution that utilizes a portion of main memory 110 of the collection device 24, such as random access memory (RAM) and processing from the processor 102 or may be a dedicated graphic processing unit. In another embodiment, the display interface 106 and display 108 can additionally provide a touch screen interface for providing data to the collection device 24 in a well-known manner.

Main memory 110 in one embodiment can be random access memory (RAM), and in other embodiments may include other memory such as a ROM, PROM, EPROM or EEPROM, and combinations thereof. In one embodiment, the collection device 24 can include secondary memory 112, which may include, for example, a hard disk drive 114 and/or a computer readable medium drive 116 for the computer readable medium 40, representing for example, at least one of a floppy disk drive, a magnetic tape drive, an optical disk drive, a flash memory connector (e.g., USB connector, Firewire connector, PC card slot), etc. The drive 116 reads from and/or writes to the computer readable medium 40 in a well-known manner. Computer readable medium 40, represents a floppy disk, magnetic tape, optical disk (CD or DVD), flash drive, PC card, etc. which is read by and written to by the drive 116. As will be appreciated, the computer readable medium 40 can have stored therein the software 34 and/or biomarker data 70 resulting from completed collections performed according to one or more of the collection procedures.

In alternative embodiments, secondary memory 112 may include other means for allowing the software 34, other computer programs or other instructions to be loaded into the collection device 24. Such means may include, for example, a removable storage unit 120 and an interface connector 122. Examples of such removable storage units/interfaces can include a program cartridge and cartridge interface, a removable memory chip (e.g., ROM, PROM, EPROM, EEPROM, etc.) and associated socket, and other removable storage units 120 (e.g. hard drives) and interface connector 122 which allow software and data to be transferred from the removable storage unit 120 to the collection device 24.

The collection device 24 in one embodiment can include a communication module 124. The communication module 124 allows software and data (e.g., biomarker data 70 resulting from completed collections) to be transferred between the collection device 24 and an external device(s) 126. Examples of communication module 124 may include one or more of a modem, a network interface (such as an Ethernet card), a communications port (e.g., USB, Firewire, serial, parallel, etc.), a PC or PCMCIA slot and card, a wireless transceiver, and combinations thereof. The external device(s) 126 can be the patient computer 18, the clinician computer 25, the handheld computing devices 36, such as a laptop computer, a personal digital assistance (PDA), a mobile (cellular) phone, and/or a dongle, a docking station, or device reader 22. In such an embodiment, the external device 126 may provide and/or connect to one or more of a modem, a network interface (such as an Ethernet card), a communications port (e.g., USB, Firewire, serial, parallel, etc.), a PCMCIA slot and card, a wireless transceiver, and combinations thereof for providing communication over the public network 50 or private network, such as with the clinician computer 25 or server 52. Software and data transferred via communication module 124 can be in the form of wired or wireless signals 128, which may be electronic, electromagnetic, optical, or other signals capable of being sent and received by communication module 124. For example, as is known, signals 128 may be sent between communication module 124 and the external device(s) 126 using wire or cable, fiber optics, a phone line, a cellular phone link, an RF link, an infrared link, other communications channels, and combinations thereof. Specific techniques for connecting electronic devices through wired and/or wireless connections (e.g. USB and Bluetooth, respectively) are well known in the art.

In another embodiment, the collection device 24 can be used with the external device 132, such as provided as a handheld computer or a mobile phone, to perform actions such as prompt a patient to take an action, acquire a data event, and perform calculations on information. An example of a collection device combined with such an external device 126 provided as a hand held computer is disclosed in U.S. patent application Ser. No. 11/424,757 filed Jun. 16, 2006 entitled “System and method for collecting patient information from which diabetes therapy may be determined,” assigned to Roche Diagnostics Operations, Inc., which is hereby incorporated by reference. Another example of a handheld computer is shown in the user guide entitled “Accu-Chek® Pocket Compass Software with Bolus Calculator User Guide” (2007) available from Roche Diagnostics.

In the illustrative embodiment, the collection device 24 can provide a measurement engine 138 for reading a biosensor 140. The biosensor 140, which in one embodiment is the disposable test strip 30 (FIG. 1), is used with the collection device 24 to receive a sample such as for example, of capillary blood, which is exposed to an enzymatic reaction and measured by electrochemistry techniques, optical techniques, or both by the measurement engine 138 to measure and provide a biomarker value, such as for example, a blood glucose level. An example of a disposable test strip and measurement engine is disclosed in U.S. Patent Pub. No. 2005/0016844 A1 “Reagent stripe for test strip” (Jan. 27, 2005), and assigned to Roche Diagnostics Operations, Inc., which is hereby incorporated by reference. In other embodiments, the measurement engine 138 and biosensor 140 can be of a type used to provide a biomarker value for other types of sampled fluids or analytes besides or in addition to glucose, heart rate, blood pressure measurement, and combinations thereof. Such an alternative embodiment is useful in embodiments where values from more than one biomarker type are requested by a structured collection procedure according to the present disclosure. In still another embodiment, the biosensor 140 may be a sensor with an indwelling catheter(s) or being a subcutaneous tissue fluid sampling device(s), such as when the collection device 24 is implemented as a continuous glucose monitor (CGM) in communication with an infusion device, such as insulin pump 46 (FIG. 1). In further embodiments, the collection device 24 can be a controller implementing the software 34 and communicating between the infusion device (e.g., ambulatory insulin pump 46 and electronic insulin pen 48) and the biosensor 140.

Data, comprising at least the information collected by the biosensor 140, is provided by the measurement engine 138 to the processor 102 which may execute a computer program stored in memory 110 to perform various calculations and processes using the data. For example, such a computer program is described by U.S. patent application Ser. No. 12/492,667, filed Jun. 26, 2009, titled “Method, System, and Computer Program Product for Providing Both an Estimated True Mean Blood Glucose Value and Estimated Glycated Hemoglobin (HbAlC) Value from Structured Spot Measurements Of Blood Glucose,” and assigned to Roche Diagnostics Operations, Inc., which is hereby incorporated by reference. The data from the measurement engine 138 and the results of the calculation and processes by the processor 102 using the data is herein referred to as self-monitored data. The self-monitored data may include, but not limited thereto, the glucose values of a patient 12, the insulin dose values, the insulin types, and the parameter values used by processor 102 to calculate future glucose values, supplemental insulin doses, and carbohydrate supplement amounts as well as such values, doses, and amounts. Such data along with a date-time stamp for each measured glucose value and administered insulin dose value is stored in a data file 145 of memory 110 and/or 112. An internal clock 144 of the collection device 24 can supply the current date and time to processor 102 for such use.

The collection device 24 can further provide a user interface 146, such as buttons, keys, a trackball, touchpad, touch screen, etc. for data entry, program control and navigation of selections, choices and data, making information requests, and the like. In one embodiment, the user interface 146 can comprises one or more buttons 147, 149 for entry and navigation of the data provided in memory 110 and/or 112. In one embodiment, the user can use one or more of buttons 147, 149 to enter (document) contextualizing information, such as data related to the everyday lifestyle of the patient 12 and to acknowledge that prescribed tasks are completed. Such lifestyle data may relate to food intake, medication use, energy levels, exercise, sleep, general health conditions and overall well-being sense of the patient 12 (e.g., happy, sad, rested, stressed, tired, etc.). Such lifestyle data can be recorded into memory 110 and/or 112 of the collection device 24 as part of the self-monitored data via navigating through a selection menu displayed on display 108 using buttons 147, 149 and/or via a touch screen user interface provided by the display 108. It is to be appreciated that the user interface 146 can also be used to display on the display 108 the self monitored data or portions thereof, such as used by the processor 102 to display measured glucose levels as well as any entered data.

In one embodiment, the collection device 24 can be switched on by pressing any one of the buttons 147, 149 or any combination thereof. In another embodiment, in which the biosensor 140 is a test-strip, the collection device 24 can be automatically switched on when the test-strip is inserted into the collection device 24 for measurement by the measurement engine 138 of a glucose level in a sample of blood placed on the test-strip. In one embodiment, the collection device 24 can be switched off by holding down one of the buttons 147, 149 for a pre-defined period of time, or in another embodiment can be shut down automatically after a pre-defined period of non-use of the user interface 146.

An indicator 148 can also be connected to processor 102, and which can operate under the control of processor 102 to emit audible, tactile (vibrations), and/or visual alerts/reminders to the patient of daily times for bG measurements and events, such as for example, to take a meal, of possible future hypoglycemia, and the like. A suitable power supply 150 is also provided to power the collection device 24 as is well known to make the device portable.

As mentioned above previously, the collection device 24 may be pre-loaded with the software 34 or be provided therewith via the computer readable medium 40 as well as received via the communication module 124 by signal 128 directly or indirectly though the external device 132 and/or network 50. When provided in the latter matter, the software 34 when received by the processor 102 of the collection device 24 is stored in main memory 110 (as illustrated) and/or secondary memory 112. The software 34 contains instructions, when executed by the processor 102, enables the processor to perform the features/functions of the present invention as discussed herein in later sections. In another embodiment, the software 34 may be stored in the computer readable medium 40 and loaded by the processor 102 into cache memory to cause the processor 102 to perform the features/functions of the invention as described herein. In another embodiment, the software 34 is implemented primarily in hardware logic using, for example, hardware components such as application specific integrated circuits (ASICs). Implementation of the hardware state machine to perform the feature/functions described herein will be apparent to persons skilled in the relevant art(s). In yet another embodiment, the invention is implemented using a combination of both hardware and software.

In an example software embodiment of the invention, the methods described hereafter can be implemented in the C++programming language, but could be implemented in other programs such as, but not limited to, Visual Basic, C, C#, Java or other programs available to those skilled in the art. In still other embodiment, the software 34 may be implemented using a script language or other proprietary interpretable language used in conjunction with an interpreter.

It is to be appreciated that biomarker data 70, which can include or be associated with self-monitored data and/or contextual information can be sent/downloaded (wired or wireless) from the collection device 24 via the communication module 124 to another electronic device, such as the external device 132 (PC, PDA, or cellular telephone), or via the network 50 to the clinician computer 25. Clinicians can use diabetes software provided on the clinician computer 25 to evaluate the received biomarker data 70 of the patient 12 for therapy results. An example of some of the functions which may be incorporated into the diabetes software and which is configured for a personal computer is the Accu-Chek® 360 Diabetes Management System available from Roche Diagnostics that is disclosed in U.S. patent application Ser. No. 11/999,968 filed Dec. 7, 2007, titled “METHOD AND SYSTEM FOR SETTING TIME BLOCK,” and assigned to Roche Diagnostics Operations, Inc., which is hereby incorporated by reference.

In one embodiment, the collection device 24 can be provided as portable blood glucose meter, which is used by the patient 12 for recording self-monitored data comprising insulin dosage readings and spot measured glucose levels. Examples of such bG meters as mentioned above previously include but are not limited to, the Accu-Chek® Active meter and the Accu-Chek® Aviva system both by Roche Diagnostics, Inc. which are compatible with the Accu-Chek® 360° Diabetes management software to download test results to a personal computer or the Accu-Chek® Pocket Compass Software for downloading and communication with a PDA. Accordingly, it is to be appreciated that the collection device 24 can include the software and hardware necessary to process, analyze and interpret the self monitored data in accordance with predefined flow sequences (as described below in detail) and generate an appropriate data interpretation output. In one embodiment, the results of the data analysis and interpretation performed upon the stored patient data by the collection device 24 can be displayed in the form of a report, trend-monitoring graphs, and charts to help patients manage their physiological condition and support patient-doctor communications. In other embodiments, the bG data from the collection device 24 may be used to generate reports (hardcopy or electronic) via the external device 132 and/or the patient computer 18 and/or the clinician computer 25.

The collection device 24 can further provide the user and/or his or her clinician with at least one or more of the possibilities comprising: a) editing data descriptions, e. g. the title and description of a record; b) saving records at a specified location, in particular in user-definable directories as described above; c) recalling records for display; d) searching records according to different criteria (date, time, title, description etc.); e) sorting records according to different criteria (e.g., values of the bG level, date, time, duration, title, description, etc.); f) deleting records; g) exporting records; and/or h) performing data comparisons, modifying records, excluding records as is well known.

In still another embodiment, the software 34 can be implemented on the continuous glucose monitor 28 (FIG. 1). In this manner, the continuous glucose monitor 28 can be used to obtain time-resolved data. Such time-resolved data can be useful to identify fluctuations and trends that would otherwise go unnoticed with spot monitoring of blood glucose levels and standard HbAlc tests. Such as, for example, low overnight glucose levels, high blood glucose levels between meals, and early morning spikes in blood glucose levels as well as how diet and physical activity affect blood glucose along with the effect of therapy changes.

In addition to collection device 24, clinicians 14 can prescribe other diabetes therapy devices for patients 12 such as an ambulatory insulin pump 46 as well as electronically based insulin pen 48 (FIG. 1). The insulin pump 46 typically includes configuration software such as that disclosed in the manual “Accu-Chek® Insulin Pump Configuration Software” also available from Roche Diagnostics. The insulin pump 46 can record and provide insulin dosage and other information, as well as the electronically based insulin pen 48, to a computer, and thus can be used as another means for providing biomarker data.

It is to be appreciated that embodiments of the computer implemented method described hereinafter can be implemented electronically on system 41 (FIG. 2), patient computer 18, clinician computer 25, collection device 24 or on any electronic device/computer that includes a display. Specifically, when the computer implemented method is executed as a program, i.e., software 34, instructions codes of the program can be executed by one or more processors (e.g., processor 76, processor 102, graphics processor 80, and/or display interface 106) to perform the processes associated therewith. In still other embodiments, some or all of the processes of the software 34 discussed hereafter provided on a non-transient computer readable medium 40 storing program instruction codes that, when executed by one or more processors, causes at least a display communicatively coupled to the one or more processors to perform the processes associated therewith.

Referring collectively to FIGS. 2-4, the software 34 causes one or more processors (e.g., processor 76, processor 102, graphics processor 80, and/or display interface 106) to automatically provide a graphical user interface visually on an electronic display (e.g., display 82 and/or display 108) as an event analysis window 200. The event analysis window 200 can comprise an event type control 202 positioned within the event analysis window 200 and a graphical window 204 positioned within the event analysis window 200. The event type control 202 can be any control configured to manipulate the events that are displayed within the graphical window 204, i.e., the data displayed within the graphical window 204 can be based upon input received by the event type control 202. In some embodiments, the event type control 202 can provide input to the one or more processors that determines the number of windows that the one or more processors will automatically display within the event analysis window 200. Specifically, the one or more processors via the event type control 202 can receive automatically event selection input indicative of a desired analysis of an event. Each desired analysis can be associated with a predetermined number of windows to be displayed within the event analysis window 200.

Specific examples of desired analyses include meal comparison, breakfast comparison, lunch comparison, dinner comparison and criteria select. A meal comparison analysis can include a graphical window 204 for each regularly scheduled meal displayed within the graphical window 204. A breakfast analysis can include a graphical window 204 for breakfast displayed within the event analysis window 200. A lunch analysis can include a graphical window 206 for lunch displayed by the one or more processors automatically within the event analysis window 200. A dinner analysis can include a graphical window 208 for dinner displayed by the one or more processors automatically within the event analysis window 200. As is explained in further detail below, criteria select analysis can include a graphical window 204 associated with desired criteria displayed within the event analysis window 200.

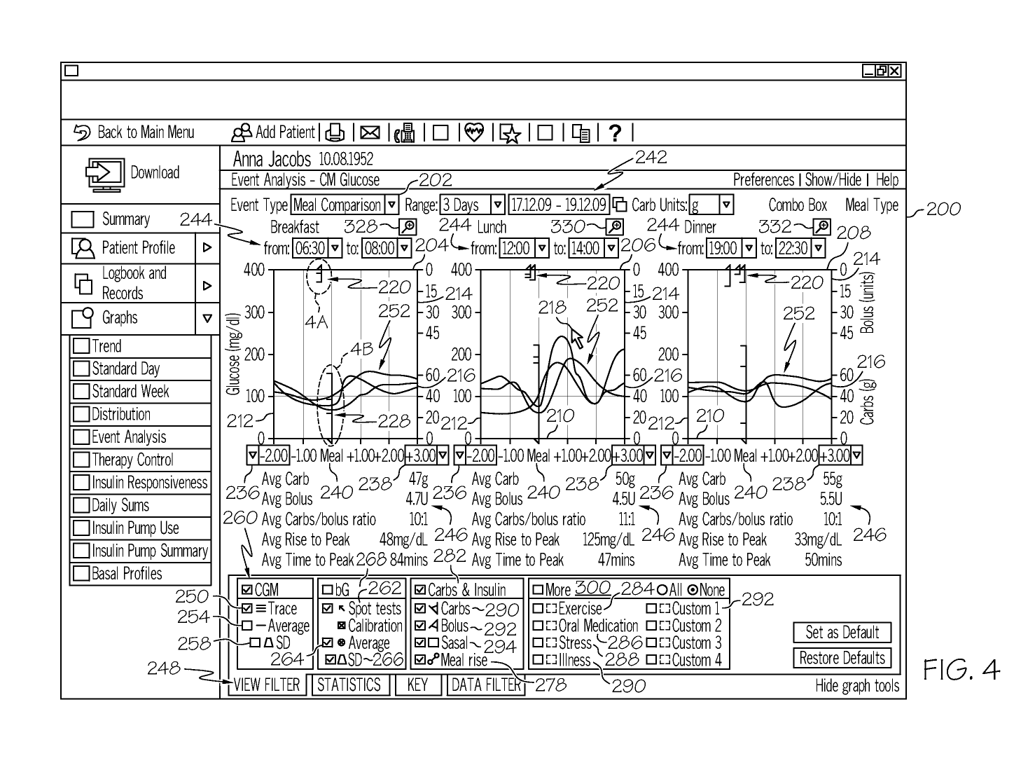

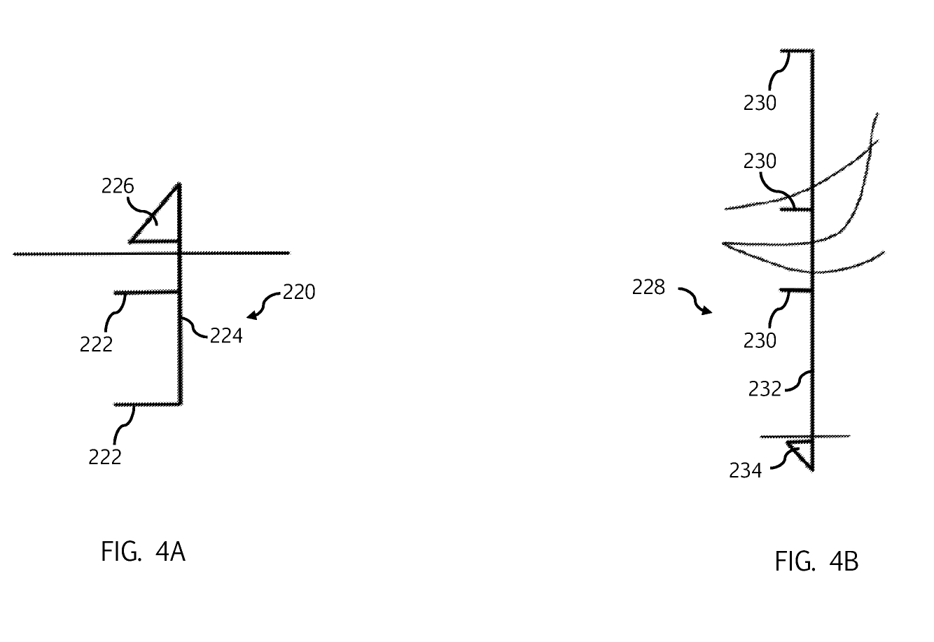

In the embodiment depicted in FIG. 4, the meal comparison analysis is schematically depicted. In the depicted embodiment, the event analysis window 200 comprises a graphical window 204 associated with breakfast, a graphical window 206 associated with lunch, and a graphical window 208 associated with dinner. The graphical window 204 comprises a time abscissa axis 210 that defines time units (e.g., hours) within the graphical window 204, a glucose ordinate axis 212 that defines glucose units (e.g., mg/dL) within the graphical window 204, and a bolus ordinate axis 214 that defines bolus units within the graphical window 204. The glucose ordinate axis 212 can span the entire height of the graphical window 204 and define a scale that increases vertically. The bolus ordinate axis 214 can span only a portion of the graphical window 204 and define a scale that decreases vertically. Accordingly, glucose data and bolus data can be displayed contemporaneously without obscuring one another. Each of the graphical window 206 and the graphical window 208 can comprise a time abscissa axis 210, a glucose ordinate axis 212, and a bolus ordinate axis 214 in a manner substantially equivalent to the graphical window 204.

In some embodiments, the graphical window 204 can comprise a carbohydrate ordinate axis 216 that defines carbohydrate units (e.g., g) within the graphical window 204. The carbohydrate ordinate axis 216 can span only a portion of the graphical window 204 and define a scale that increases vertically. Accordingly, glucose data, bolus data, and carbohydrate data can be displayed contemporaneously without obscuring one another. Each of the graphical window 206 and the graphical window 208 can comprise a carbohydrate ordinate axis 216 in a manner substantially equivalent to the graphical window 204. Additionally, it is noted that, while each of graphical window 204, 206, 208 is depicted in FIG. 4 as including a glucose ordinate axis 212, a bolus ordinate axis 214, and a carbohydrate ordinate axis 216, each graphical window 204, 206, 208 can include one, both or all three of the glucose ordinate axis 212, the bolus ordinate axis 214, and the carbohydrate ordinate axis 216. Furthermore it is noted that each of the glucose ordinate axis 212, the bolus ordinate axis 214, and the carbohydrate ordinate axis 216 can vertically span only a portion of or all of the graphical window 204, 206, 208. Moreover, each of the glucose ordinate axis 212, the bolus ordinate axis 214, and the carbohydrate ordinate axis 216 can include a vertically increasing scale or a vertically decreasing scale.

Referring collectively to FIGS. 4 and 4A, the event analysis window 200 can comprise a plurality of bolus icons 220 for indicating a bolus amount and a bolus time. Each of plurality of bolus icons 220 comprises a bolus indication object 222 that is aligned with the bolus ordinate axis 214 within the graphical window 204, a bolus time indication object 224 that is aligned with the time abscissa axis 210 within in the graphical window 204, and a bolus symbol 226 that is presented outside of the graphical window 204. The bolus time indication object 224 can extend from the bolus indication object 222 to the bolus symbol 226. The bolus indication object 222 can be any shape suitable to be aligned with a bolus value along the bolus ordinate axis 214 that is indicative of the bolus amount such as, for example, a substantially horizontal line or a two-dimensional shape having a substantially straight edge or facet. The bolus time indication object 224 can be any shape suitable to be aligned with a time value along the time abscissa axis 210 that is indicative of the bolus time such as, for example, a substantially vertical line. The bolus symbol 226 can be any shape that is suitable to be viewed outside of the graphical window 204. Accordingly, it is noted that, while the bolus symbol 226 is depicted as being substantially triangular, the bolus symbol 226 can be any visual indication such as an image, a shape, text, or the like.

Referring collectively to FIGS. 4 and 4B, the event analysis window 200 can comprise a plurality of carbohydrate icons 228 for indicating a carbohydrate amount and a carbohydrate time. Each of the plurality of carbohydrate icons 228 comprises a carbohydrate indication object 230 that is aligned with the carbohydrate ordinate axis 216 within the graphical window 204, a carbohydrate time indication object 232 that is aligned with the time abscissa axis 210 within in the graphical window 204, and a carbohydrate symbol 234 that is presented outside of the graphical window 204. The carbohydrate time indication object 232 can extend from the carbohydrate indication object 230 to the carbohydrate symbol 234. The carbohydrate indication object 230 can be any shape suitable to be aligned with a carbohydrate value along the carbohydrate ordinate axis 216 that is indicative of the carbohydrate amount such as, for example, a substantially horizontal line or a two-dimensional shape having a substantially straight edge or facet. The carbohydrate time indication object 232 can be any shape suitable to be aligned with a time value along the time abscissa axis 210 that is indicative of the bolus time such as, for example, a substantially vertical line. The carbohydrate symbol 234 can be any shape that is suitable to be viewed outside of the graphical window 204. Accordingly, it is noted that, while the carbohydrate symbol 234 is depicted as being substantially triangular, the carbohydrate symbol 234 can be any visual indication such as an image, a shape, text, or the like.

Referring again to FIG. 4, the time abscissa axis 210 can be configured with one or more controls for altering the start time and the end time of the time abscissa axis 210. In the depicted embodiment, the time abscissa axis 210 comprises a start time control 236 and an end time control 238. Accordingly, the one or more processors via the start time control 236 can receive input and adjust automatically the start time of the time abscissa axis 210. Similarly, the one or more processors via the stop time control 238 can receive input and adjust automatically the stop time of the time abscissa axis 210. In some embodiments, the time abscissa axis 210 can comprise a meal time 240 and the start time and the stop time can be normalized to the meal time 240. Specifically, the one or more processors via the start time control 236 and the end time control 238 can be configured to receive input in time units with respect to the meal time. For example, the one or more processors via the start time control 236 can receive input in negative time units and the one or more processors via the stop time control 238 can receive input in positive time units. Accordingly, the start time and the end time of the time abscissa axis 210 can be set to a desired time range with respect to the meal time 240.

The event analysis window 200 can comprise a date range control 242 for determining the appropriate biomarker data 70 (FIGS. 2 and 3) to include in the event analysis. The one or more processors via the date range control 242 can receive input indicative of a range of dates that can be associated with biomarker data 70. Specifically, the one or more processors via the date range control 242 can be configured to receive input of a range of dates and/or a specific number of days that can be associated with a range of dates.

The event analysis window 200 can comprise one or more controls for specifying a range of actual times during which the reference time 240 occurs. In one embodiment, the event analysis window comprises a reference range control 244 for each of the graphical windows 204, 206, 208. The one or more processors via the reference range control 244 can receive input indicative of a selected range of actual times. The selected range of actual times can be indicative of the time of day that the event of the desired analysis occurred. For example, the biomarker data 70 can be indexed according to time that overlaps with the selected range of actual times.

The event analysis window 200 can comprise one or more event information windows 246 for providing absolute numbers associated with the desired analysis. For example, an event information window 246 can be associated by the one or more processors with each of the graphical windows 204, 206, 208 and the one or more processors can provide calculations automatically based upon biomarker data 70 (FIGS. 2 and 3) collected between the start time and the end time of the time abscissa axis 210. Specifically, the average of carbohydrate values in units of g can be calculated automatically by the one or more processors based upon biomarker data 70 collected between the start time and the end time of the time abscissa axis 210. The average bolus can be calculated automatically by the one or more processors based upon biomarker data 70 collected between the start time and the end time of the time abscissa axis 210. The average carbohydrate to average bolus ratio can be calculated automatically by the one or more processors based upon biomarker data 70 collected between the start time and the end time of the time abscissa axis 210. The average rise to peak in units of mg/dL can be calculated automatically by the one or more processors based upon biomarker data 70 collected between the start time and the end time of the time abscissa axis 210. The average time to peak in units of minutes can be calculated automatically by the one or more processors based upon biomarker data 70 collected between the start time and the end time of the time abscissa axis 210.

The event analysis window 200 can comprise a view filter tab 248 for providing controls that are configured to manage the data provided by each of the graphical windows 204, 206, 208. The view filter tab 248 can comprise a trace control 250 that when selected causes continuous glucose monitoring (CGM) traces 252 to be displayed by the one or more processors automatically in the graphical windows 204, 206, 208. Each of the CGM traces 252 can be based upon biomarker data 70 (FIGS. 2 and 3) collected during one of the dates in the range of dates. When the trace control 250 is deselected, the CGM traces 252 are not displayed by the one or more processors.

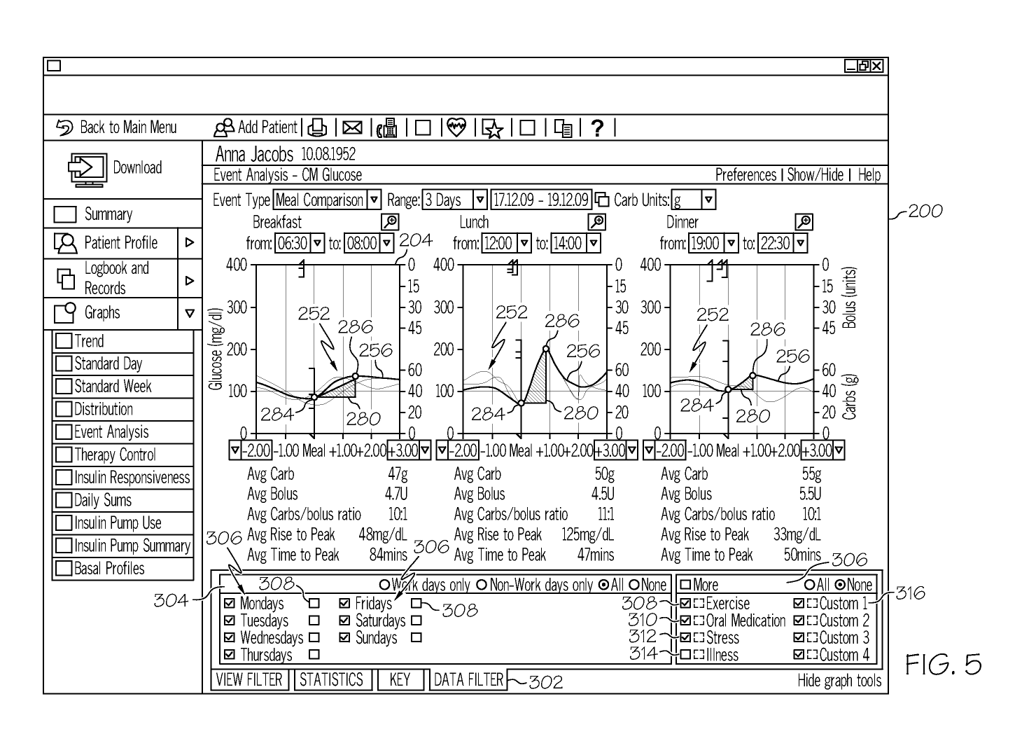

The view filter tab 248 can comprise an average trace control 254 that when selected causes average trace 256 (FIG. 4) to be displayed in the graphical windows 204, 206, 208. The average trace 256 can be based upon the CGM traces 252 displayed by the one or more processors within the graphical windows 204, 206, 208. When the average trace control 254 is deselected, the average trace 256 is not displayed by the one or more processors. The view filter tab 248 can further comprise a standard deviation control 256 that is associated with the average trace control 254. In one embodiment, the standard deviation control 256 can be grayed out automatically by the one or more processors when the average trace control 256 is deselected and displayed at full brightness by the one or more processors automatically when the average trace control 256 is selected. When the standard deviation control 256 is selected, a standard deviation (not depicted) of the CGM traces 252 can be displayed by the one or more processors automatically adjacent to the average trace 256 (FIG. 5). When the standard deviation control 256 is deselected, the standard deviation of the CGM traces 252 is not displayed by the one or more processors.

The trace control 250, average trace control 256, and the standard deviation control 256 can be associated with a global CGM control 260 that is configured to override the trace control 250, average trace control 256, and the standard deviation control 256 when deselected. Specifically, when the global CGM control 260 is deselected, the one or more processors automatically operate the graphical windows 204, 206, 208 as though each of the trace control 250, average trace control 256, and the standard deviation control 256 has been individually deselected. In such a state, the trace control 250, average trace control 256, and the standard deviation control 256 can be grayed out by the one or more processors automatically and configured to receive input. When the global CGM control 260 is selected, input provided to processor via the trace control 250, average trace control 256, and the standard deviation control 256 manages the graphical windows 204, 206, 208.

The view filter tab 248 can further comprise controls for biomarker data 70 (FIGS. 2 and 3) obtained through spot monitoring of blood glucose levels that operate in a manner analogous to the controls associated with CGM data. Specifically, the view filter tab 248 can comprise a bG test control 262, an average bG control 264, and a standard deviation bG control 266. When the bG test control 262 is selected, spot tests and calibrations (not depicted) are displayed by the one or more processors automatically in the graphical windows 204, 206, 208. When the bG test control 262 is deselected, the spot tests and calibrations are not displayed by the one or more processors. When the average bG control 264 is selected, an average (not depicted) of the spot tests is displayed by the one or more processors automatically in the graphical windows 204, 206, 208. When the average bG control 264 is deselected, the average of the spot tests is not displayed by the one or more processors. The standard deviation bG control 266 can be associated with the average trace control 254. In one embodiment, the standard deviation bG control 266 can be grayed out by the one or more processors automatically when the average bG control 264 is deselected and displayed at full brightness by the one or more processors automatically when average bG control 264 is selected. When the standard deviation bG control 266 is selected, a standard deviation (not depicted) of the spot tests can be displayed by the one or more processors automatically adjacent to the average of the spot tests. When the standard deviation bG control 266 is deselected, the standard deviation of the spot tests is not displayed by the one or more processors. Additionally, the bG test control 262, the average bG control 264, and the standard deviation bG control 266 can be associated with a global bG control 268. The global bG control 268 can interact with the bG test control 262, the average bG control 264, and the standard deviation bG control 266 in a manner substantially similar to the global CGM control 260 described hereinabove.

The view filter tab 248 can comprise a carbohydrate display control 270 that when selected causes the carbohydrate icons 228 to be displayed by the one or more processors automatically in the graphical windows 204, 206, 208. When the carbohydrate display control 270 is deselected, the carbohydrate icons 228 are not displayed by the one or more processors. Additionally or alternatively, the view filter tab 248 can comprise a bolus display control 272 that when selected causes the bolus icons 220 to be displayed by the one or more processors automatically in the graphical windows 204, 206, 208. When the bolus display control 272 is deselected, the bolus icons 220 are not displayed by the one or more processors.

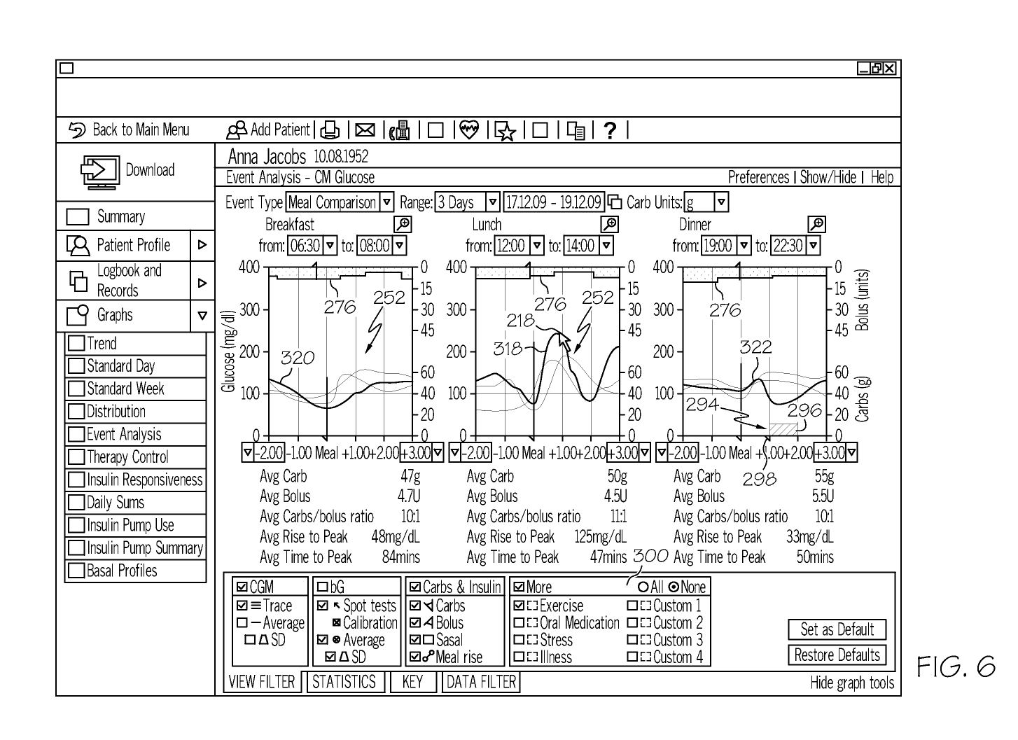

Referring now to FIG. 6, the view filter tab 248 can further comprise a basal display control 274 that when selected causes the basal graphical object 276 to be plotted by the one or more processors automatically in the graphical windows 204, 206, 208. Specifically, the basal graphical object 276 can be scaled according to the time abscissa axis 210 and the bolus ordinate axis 214 such that the basal graphical object 276 is indicative of a basal rate of insulin injected over time. When the basal display control 274 is deselected, the basal graphical object 276 is not displayed by the one or more processors. Additionally or alternatively, the view filter tab 248 can comprise a meal rise control 278 that when selected can cause the meal rise icon 280 (FIG. 5) to be displayed by the one or more processors automatically in the graphical windows 204, 206, 208. When the meal rise control 278 is deselected, the meal rise icon 280 is not displayed by the one or more processors. The carbohydrate display control 270, the bolus display control 272, the basal display control 274, and the meal rise control 278 can be associated with a global carbohydrate and insulin control 282 that is configured to override the carbohydrate display control 270, the bolus display control 272, the basal display control 274, and the meal rise control 278 in a manner substantially similar to the global CGM control 260 described hereinabove.

The view filter tab 248 can further comprise controls for lifestyle data, which can be collected and associated with blood glucose data. The lifestyle data can be associated with time stamps indicative of when the lifestyle data was collected. The view filter tab 248 can comprise lifestyle controls such as, but not limited to, an exercise display control 284, an oral medication display control 286, a stress display control 288, an illness display control 290, and a custom display control 292. When the exercise display control 284 is selected, an exercise icon 294 can be displayed by the one or more processors automatically in the graphical window 208. The exercise icon 294 comprises a time extent indication object 296 that is aligned with the time abscissa axis 210 within the graphical window 208 and an exercise symbol 298 that is presented by the one or more processors automatically outside of the graphical window 208. The time extent indication object 296 can be any shape suitable to be aligned with a start time and an end time along the time abscissa axis 210 that is indicative of the duration of the exercise such as, for example, a substantially rectangular shape. The exercise symbol 298 can be any shape that is suitable to be viewed outside of the graphical window 208. Accordingly, it is noted that, while the exercise symbol 298 is depicted as being substantially triangular, the exercise symbol 298 can be any visual indication such as an image, a shape, text, or the like. It is furthermore noted that, while the exercise icon 294 is depicted in FIG. 6 in only the graphical window 208, the exercise icon 294 can be plotted in any graphical window by the one or more processors automatically that has a time abscissa axis 210 that is coincident with the time period defined by the exercise icon 294.

When the exercise display control 284 is deselected, the exercise icon 294 is not displayed by the one or more processors. Each of the oral medication display control 286, the stress display control 288, the illness display control 290, and the custom display control 292 operates in a manner substantially similar to the exercise display control 284. Specifically, the oral medication display control 286 can toggle the display of an oral medication icon (not depicted) in the graphical windows 204, 206, 208 provided by the one or more processors. The oral medication icon is indicative of the start time and the absorption time of an oral medication. The stress display control 288 can toggle the display of a stress icon (not depicted) in the graphical windows 204, 206, 208 provided by the one or more processors. The stress icon is indicative of the start time and the duration of stressful time period. The illness display control 290 can toggle the display of an illness icon (not depicted) in the graphical windows 204, 206, 208 provided by the one or more processors. The illness icon is indicative of the start time and the duration of a period of illness. The custom display control 292 can toggle the display of a custom lifestyle icon (not depicted) in the graphical windows 204, 206, 208 provided by the one or more processors. The custom lifestyle icon can be indicative of the start time and the duration of a period of time that coincides with contextual label (e.g., text input) that is associated with the time period. Each of the oral medication icon, the stress icon, the illness icon, and custom lifestyle icon can be displayed by the one or more processors automatically in a manner substantially similar to the exercise icon 294.

Additionally, the exercise display control 284, the oral medication display control 286, the stress display control 288, the illness display control 290, and the custom display control 292 can be associated by the one or more processors automatically with a global lifestyle control 300. The global lifestyle control 300 can interact with the exercise display control 284, the oral medication display control 286, the stress display control 288, the illness display control 290, and the custom display control 292 in a manner substantially similar to the global CGM control 260 described hereinabove. In some embodiments, the one or more processors via the global lifestyle control 300 can further be configured to accept input that selects or deselects all of the controls associated with the global lifestyle control 300.

Referring again to FIG. 5, the event analysis window 200 can comprise a data filter tab 302 for providing color mapping and filtering of data for inclusion by the one or more processors automatically in the event information window 246. The data filter tab 302 can comprise a day control 304 for selecting days of the week for inclusion in the calculations performed by the one or more processors automatically within the event information window 246 and for setting the color of each of the CGM traces 252. The day control 304 can comprise a plurality of day controls 306 that are each associated with a day of the week. When selected each of the day controls 306 is selected, the associated day of the week is included in the calculations performed by the one or more processors automatically for the event information window 246. When each of the day controls 306 is deselected, the associated day of the week is excluded from the calculations performed by the one or more processors for the event information window 246. The one or more processors via the day control 304 can be configured to receive input that selects and deselects groups of the day controls 306. For example, the one or more processors via the day control 304 can receive input that selects work days only, non-work days only, and all days or deselects all days. The day control 304 can further comprise a plurality of color controls 308 that are each associated by the one or more processors with a day of the week, and configure the one or more processors to receive input indicative of a desired color. Accordingly, each of the CGM traces 252 can correspond to one of the days of the week, and be set to the desired color, i.e., each of the CGM traces 252 can be color coded based upon the desired color.

The data filter tab 302 can comprise lifestyle calculation control 306 for filtering data that is coincident with a lifestyle event for inclusion in the event information window 246. The lifestyle calculation control 306 can be associated by the one or more processors automatically with an exercise calculation control 308, an oral medication calculation control 310, a stress calculation control 312, an illness calculation control 314, and a custom calculation control 316. When each of the exercise calculation control 308, the oral medication calculation control 310, the stress calculation control 312, the illness calculation control 314, and the custom calculation control 316 is selected, data that is coincident with the selected lifestyle event is included by the one or more processors automatically in the calculations of the event information window 246. When each of the exercise calculation control 308, the oral medication calculation control 310, the stress calculation control 312, the illness calculation control 314, and the custom calculation control 316 is deselected, data that is coincident with the deselected lifestyle event is excluded by the one or more processors automatically in the calculations of the event information window 246. The one or more processors via the lifestyle calculation control 306 can be configured to receive input that selects and deselects groups of the exercise calculation control 308, the oral medication calculation control 310, the stress calculation control 312, the illness calculation control 314, and the custom calculation control 316. For example, the one or more processors via the lifestyle calculation control 306 can receive input that selects or deselects all of the lifestyle controls associated with the lifestyle calculation control 306.

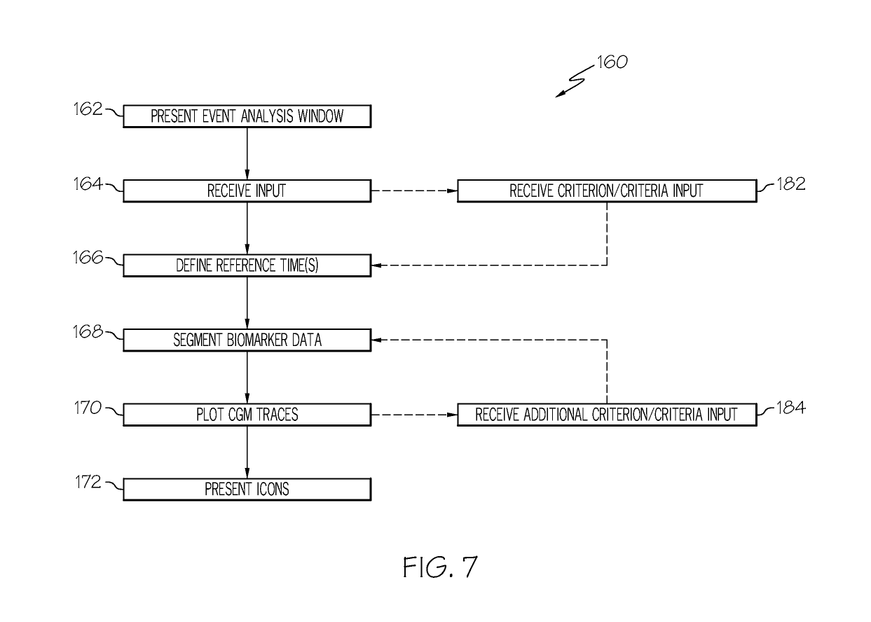

An embodiment of a method 160 for visualizing correlations between biomarker data 70 and one or more events is depicted in FIG. 7. It is noted that, while the method 160 includes enumerated processes depicted as following a specific sequence, each of the processes can be executed by one or more processors in any order or contemporaneously as a computer implemented method. Accordingly, it should be understood that the sequence depicted in method 160 is provided for clarity and not by way of limitation. It is furthermore noted that in some embodiments any of the processes of the method 160 can be omitted.

Referring collectively to FIGS. 4 and 7, the method 160 includes a process 162 for causing a processor to automatically present an event analysis window 200 on a display (e.g., display 82 depicted in FIG. 2). The event type control 202 can be positioned by the one or more processors within the event analysis window 200. At process 164 an event selection input can be received by the one or more processors automatically via the event type control 202. For example, an interaction element 218 can be controlled via user interface device 86 (FIG. 2) to provide event selection input to the one or more processors for analysis. In one embodiment, as depicted in FIG. 4, a meal comparison can be received automatically by one or more processors as the event selection input. The meal comparison can be associated with a plurality of event instances such as, for example, at least a portion of the collected biomarker data 70 or any data that is associated with the biomarker data 70. Each of the event instances can be associated with an event time, i.e., the event instances can be indexed such that the event instances can be demarcated according to time.

At process 166, a reference time 240 along the time abscissa axis 210 can be defined automatically by one or more processors. The reference time 240 generally corresponds to a normalized point in time that is indicative of the occurrence of an event. Accordingly, events can be presented visually in alignment with one another along the time abscissa axis 210. When the selection input is a meal comparison, a reference time 240 for a plurality of meals such as, but not limited to, breakfast, lunch, dinner, snack, and the like. In one embodiment, it can be assumed that an individual consumes meals in a traditional manner, i.e., the three primary meals of breakfast, lunch and dinner. A reference time 240 can be defined along the time abscissa axis 210 for a graphical window 204 that provides data for a first meal (e.g., breakfast), for a graphical window 206 that provides data for a second meal (e.g., lunch), and for a graphical window 208 that provides data for a third meal (e.g., dinner). It is noted that, while events such as meals are described above, the events can be any data that is associated with time such as, for example, exercise, ingestion of medication, stress, illness, hypoglycemia, hyperglycemia, change in blood glucose level, sleep, spot bG measurements or any other data tag that is time indexed.

In each instance, the reference time 240 can coordinate various event instances with one another such that correlations between the events and blood glucose levels (e.g., CGM data or spot bG measurements) are more readily visible. During a meal comparison, a plurality of instances of biomarker data 70 can be associated with the reference time 240 automatically by one or more processors. Specifically, the reference time 240 can be associated with a time range and a range of dates.

The time range can be a default value that is set based upon a statistical analysis of previous events instances of an individual or a population of people. For example, the time range for breakfast can be from about 7:00 A.M. to about 9:00 A.M. In some embodiments, the time range can be set based upon input received by one or more processors. For example, a reference range control 244 can be associated with the reference time 240 such that input received by the reference range control 244 sets the time range associated with the reference time 240. Accordingly, the time range associated with each reference time 240 can be customized to any lifestyle.

Similarly, the range of dates can be set to a default value such as, for example, the current date through the previous three days. Alternatively or additionally, the default value for the range of dates can be set to seven days, two weeks, three weeks, one month, two months, or three months. In some embodiments, the date range can be set based upon input received by one or more processors. For example, a date range control 242 can be associated with the reference time 240 such that input received by the date range control 242 sets the date range associated with the reference time 240. Accordingly, the date range associated with each reference time 240 can be set to include a plurality of continuous or discontinuous dates. Specifically, in some embodiments, the dates can be received as text input that lists a continuous range of dates or a discontinuous range of dates (e.g., Jan. 1, 2010; Jan. 13, 2010; and May 5, 2011). Alternatively or additionally, the date range control 242 can include a calendar widget that presents a plurality of dates graphically and receives input from the interaction element 218 that selects one or more of the presented dates.

Referring still to FIGS. 4 and 7, at process 168, biomarker data 70 can be segmented automatically by one or more processors. In some embodiments, the biomarker data 70 may comprise a plurality of blood glucose values associated with a monitoring time period. The blood glucose values can be derived from spot bG measurements and/or CGM data and associated with time values (e.g., data indicating the time and date of the measurement). The monitoring time period can be any range of time that bounds the time values associated with the blood glucose values. Accordingly, the monitoring time period can be a few minutes, a few hours, a few days, a few weeks, a few months, or a few years. The monitoring time period can also be correlated with the time between a patient with diabetes visit to a health care provider.

The plurality of blood glucose values associated with the monitoring time period can be segmented into groups of data based at least in part upon the event time. As is noted above, each event instance can be time indexed such that the occurrence of the event is associated with the event time. Accordingly, the plurality of blood glucose values can be segmented into a group of data that is coincident with the event time of one of the plurality of event instances. Specifically, CGM data can be segmented into continuous glucose monitoring traces 252 (CGM traces) each indicative of the blood glucose values such that at least a portion of each CGM trace 252 is coincident in time with the event time of one of the plurality of event instances.

At process 170, the CGM traces 252 can be plotted automatically by one or more processors the graphical window 204, the graphical window 206, the graphical window 208, or a combination thereof. Each of the plurality of the CGM traces 252 can be scaled according to the glucose ordinate axis 212 and the time abscissa axis 210. Accordingly, any portion of each of the CGM traces 252 can correspond to a glucose measurement taken during the monitoring period in accordance with biomarker data 70. As is noted above, each of the CGM traces 252 can correspond to biomarker data 70 that is associated with time values that span the monitoring time period. Accordingly, each of the CGM traces 252 can be associated with a time value that is substantially equal to the event time. The monitoring time period can be normalized and aligned with the reference time 240 by using the event time as a point of reference. Each of the CGM traces 252 can be plotted along the time abscissa axis 210 with the time value that is substantially equal to the event time aligned with the reference time and the remaining extent of each of the CGM traces 252 plotted in relative time amount with respect to the time value that is substantially equal to the event time.

For example, in embodiments that use a meal time as an event, the CGM traces 252 can be plotted along the time abscissa axis 210 with the time value that is substantially equal to the time corresponding to the consumption of a meal aligned with the reference time 240. The remaining extent of each of the CGM traces 252 can be plotted in relative time to the consumption of the meal. Specifically, decreasing time values along the time abscissa axis 210 can be indicative of the time prior to the consumption of the meal. Increasing time values along the time abscissa axis 210 can be indicative of the time following the consumption of the meal. It should be understood that, while meal consumption is described as an event in the preceding example, any event that corresponds to an event time can be utilized such as, for example, exercise, ingestion of medication, stress, illness, hypoglycemia, hyperglycemia, change in blood glucose level, sleep, spot bG measurements or any other data tag that is time indexed.

In some embodiments, the extent of each CGM trace 252 can be demarcated according to the start time and the end time of the time abscissa axis 210. The start time and/or the end time of the time range can be a default value that is set relative to the reference time 240. For example, the start time of the time abscissa axis 210 can be set to a few hours prior to the reference time 240 (e.g., −2:00) and the end of the time abscissa axis 210 can be set to a few hours after the reference time 240 (e.g., +3:00). In some embodiments, the start time and/or the end time of the time abscissa axis 210 can be set based upon input received by one or more processors. For example, a start time control 236 can be associated with the time abscissa axis 210 such that input received by the start time control 236 sets the start time associated with the time abscissa axis 210. Alternatively or additionally, a stop time control 238 can be associated with the time abscissa axis 210 such that input received by the stop time control 238 sets the stop time associated with the time abscissa axis 210. Accordingly, the start time and the end time of the time abscissa axis 210 can be modified by input received by one or more processors. Moreover, the time abscissa axis 210 and/or the extent of each CGM trace 252 can be adjusted dynamically such as each time the input is provided via the start time control 236 or the stop time control 238.

Referring still to FIGS. 4 and 7, at process 172, icons can be presented automatically by one or more processors within the event analysis window 200. In some embodiments, the icons can be selectively presented based upon values selected within the view filter tab 248. In one embodiment, the carbohydrate display control 270 can be provided within the view tab filter 248. When the carbohydrate display control 270 is selected, a plurality of carbohydrate icons 228 can be presented within the event analysis window 200 such that the carbohydrate indication object 230 and the carbohydrate time indication object 232 of each of the carbohydrate icons 228 are plotted within any of the graphical windows 204, 206, 208 and the carbohydrate symbol 234 of each of the carbohydrate icons 228 is plotted outside of the graphical windows 204, 206, 208. When the carbohydrate display control 270 is deselected, the plurality of carbohydrate icons 228 can be removed from and/or disabled for display in the event analysis window 200.

The bolus display control 272 can be provided within the view tab filter 248. When the bolus display control 272 is selected, a plurality of bolus icons 220 can be presented within the event analysis window 200 such that the bolus indication object 222 and the bolus time indication object 224 of each of the bolus icons 220 are plotted within any of the graphical windows 204, 206, 208 and the bolus symbol 226 of each of the bolus icons 220 is plotted outside of the graphical windows 204, 206, 208. When the bolus display control 272 is deselected, the plurality of bolus icons 220 can be removed from and/or disabled for display in the event analysis window 200.

According to the embodiments described herein, information provided within the graphical windows 204, 206, 208 can be color coded. Specifically, the plotted data and various components of the graphical windows 204, 206, 208 can be grouped according to common characteristics. As is noted above, each CGM traces 252 can be formed by segmenting the monitoring time period based upon time segment such as, for example, a date, a modal day, or the time range of the time abscissa axis 210. Each time segment can be associated with a color code (e.g., a unique wavelength in the visible range of the electromagnetic spectrum). Each of the CGM traces 252 can displayed according to the color code of its associated time segment. For example, the time segment can be a date and each of the CGM traces 252 can have a unique color code corresponding to the date that the biomarker data 70 underlying each of the CGM traces 252 was collected.

Additionally, the bolus icons 220 and the carbohydrate icons 228 can be color coded. In one embodiment, the bolus icon 220 can be color coded such that the bolus indication object 222 is displayed according to the color code of its associated time segment. Specifically, the time segment can be a date and the bolus indication object 222 of each of the bolus icons 220 can have a unique color code corresponding to the date. Accordingly, when one of the bolus icons 220 shares a time segment with one of the CGM traces 252, the bolus indication object 222 can be displayed with the same color code as one of the CGM traces 252. Moreover, the bolus icons 220 can be color coded to the bolus ordinate axis 214. Specifically, the bolus ordinate axis 214 can be displayed with a bolus color (e.g., a unique wavelength in the visible range of the electromagnetic spectrum). The bolus time indication object 224, the bolus symbol 226, or both of the bolus icons 220 can be displayed with the bolus color.

The carbohydrate icon 228 can be color coded such that the carbohydrate indication object 230 is displayed according to the color code of its associated time segment. Accordingly, when one of the carbohydrate icons 228 shares a time segment with one of the CGM traces 252, the carbohydrate indication object 230 can be displayed with the same color code as one of the CGM traces 252. Moreover, the carbohydrate icons 228 can be color coded to the carbohydrate ordinate axis 216. Specifically, the carbohydrate ordinate axis 216 can be displayed with a carbohydrate color (e.g., a unique wavelength in the visible range of the electromagnetic spectrum). The carbohydrate time indication object 232, the carbohydrate symbol 234, or both of the carbohydrate icons 228 can be displayed with the carbohydrate color.

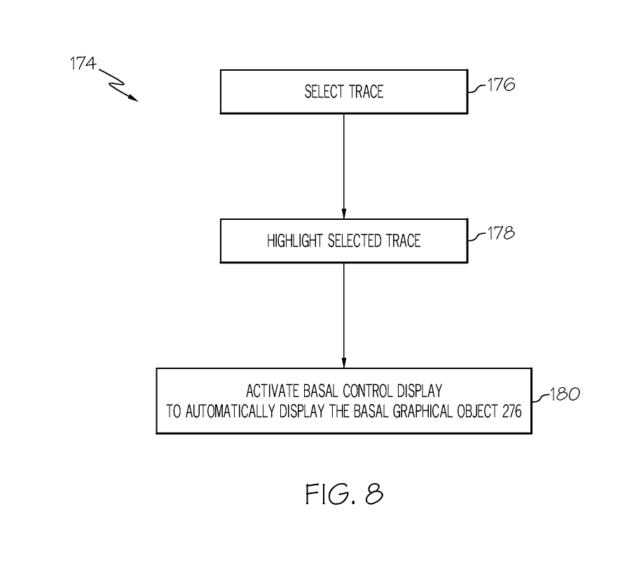

Referring collectively to FIGS. 6 and 8, the basal display control 274 can be provided within the view tab filter 248. In one embodiment, the basal display control 274 can be associated with the CGM traces 252 such that the each of the CGM traces 252 operate as a control. Specifically, each of the CGM traces 252 can be selected to invoke a method 174 for highlighting a selected trace 318 from the CGM traces 252. In one embodiment of the method 160, the basal display control 274 can be grayed out and operable to received input, i.e., capable of being selected and deselected as a default condition. Additionally, display of the basal graphical object 276 can be disabled as a default condition, i.e., regardless of whether the basal display control 274 is selected or deselected, the basal graphical object cannot be displayed when the basal display control 274 is grayed out.

At process 176, any of the CGM traces 252 can receive input such as, for example, from the interaction element 218 to be selected as the selected trace 318. At process 178, the selected trace 318 can be highlighted to distinguish the selected trace 318 from the CGM traces 252. For example, the CGM traces 252 can be grayed out, while the selected trace 318 is displayed in full color. Alternatively, the selected trace 318 can be displayed in a different color, can be displayed with an increased thickness compared to the CGM traces 252, the CGM traces 252 can be removed, or combinations thereof. At process 180, the basal display control 274 can be activated such that the basal graphical object 276 is displayed based upon the state of the basal display control 274. Specifically, the basal graphical object 276 can be displayed when the basal display control 274 is selected and not displayed the basal display control 274 is deselected. In some embodiments, a plurality of graphical windows 204, 206, 208 can be displayed simultaneously within the event analysis window 200. The selection of the selected trace 318 can be operable to cause an associated trace to be selected for multiple of the graphical windows 204, 206, 208. Specifically, the selected trace 318 of the graphical window 206 can receive input from the interaction element 218. The selected trace 320 for the graphical window 204 and selected trace 322 for the graphical window 208 can be selected automatically based upon data associated with the CGM traces 252. For example, if each of the selected traces 318, 320, 322 were collected during the same period (e.g., modal day), then the selection of the selected traces 318 can cause the selected trace 320 and the selected trace 322 to be selected automatically. Accordingly, a single input received from the interaction element 218 can cause the selected traces 318, 320, 322 to be highlighted as described above with respect to method 174.

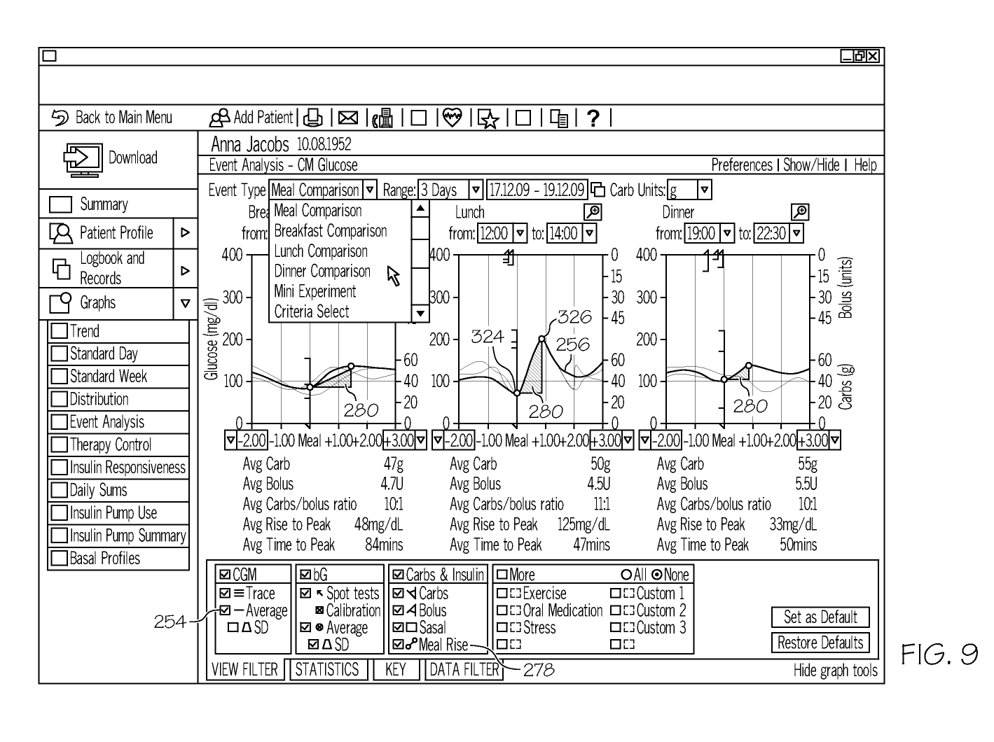

Referring now to FIG. 9, when the average trace control 254 is selected the average trace 256 can be displayed in the graphical windows 204, 206, 208. The average trace 256 can be highlighted to distinguish the average trace 256 from the CGM traces 252. For example, the CGM traces 252 can be grayed out, while the average trace 256 is displayed in full color. Moreover, the average trace 256 can be displayed in a different color compared to the CGM traces 252, can be displayed with an increased thickness compared to the CGM traces 252, the CGM traces 252 can be removed, or combinations thereof.

In some embodiments, the average trace control 254 can be associated with the meal rise control 278 such that when the average trace control 254 is deselected, the meal rise control 278 is deactivated, and when the average trace control 254 is selected, the meal rise control 278 is activated. When the meal rise control 278 is deactivated, the meal rise control 278 can be grayed out and operable to received input, i.e., capable of being selected and deselected. However, while the meal rise control 278 is deactivated, the meal rise icon 280 cannot be displayed i.e., regardless of whether the meal rise control 278 is selected or deselected, the basal graphical object cannot be displayed. When the meal rise control 278 is activated, the meal rise control 278 can be displayed normally and can be operable to control the display of the meal rise icon 280. The meal rise icon 280 can comprise a meal time graphic object 324 that is indicative of the glucose value that corresponds to the reference time 240 along the average trace 256 and a peak value graphic object 326 that is indicative of the peak glucose value along the average trace 256. It is noted that, while the meal rise icon 280 is depicted as a right triangle having a hypotenuse that extends from the meal time graphic object 324 to the peak value graphic object 326, the meal rise icon 280 can be any shape suitable to indicate the postprandial change in the blood glucose values of the average trace 256.

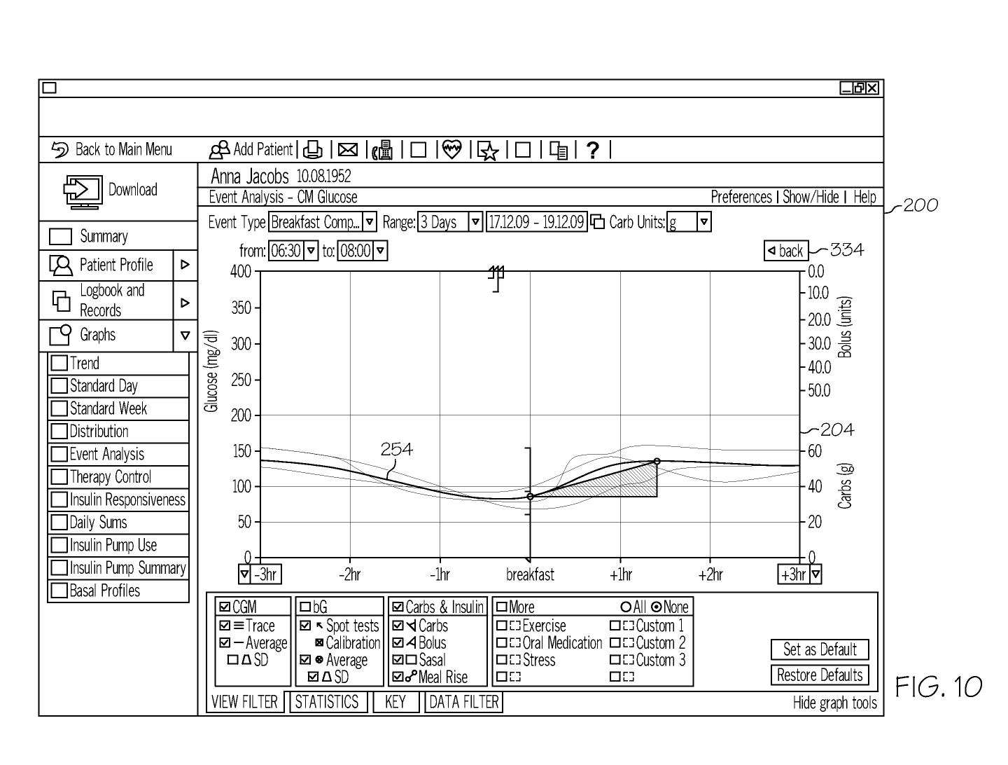

Referring back to FIG. 4, multiple events can be graphically displayed in the event analysis window 200. In some embodiments, one or more controls can be provided to receive input and provide an enlarged view of one or more of the events. For example, the event analysis window 200 can comprise a graph zoom control 328 that is associated with the graphical window 204 such that the graph zoom control 328 operates to enlarge the view of the graphical window 204. Specifically, upon receiving input via the graph zoom control 328 one or more processors can automatically provide an enlarged view (FIG. 10) of the graphical window 204. In some embodiments, the graphical window 206, the graphical window 208 and event information windows 246 can be displayed along with the graphical window 204. The graph zoom control 328 can remove the graphical window 206, the graphical window 208, and event information windows 246 from the event analysis window 200 upon receiving input. Moreover, the event analysis window can further comprise a graph zoom control 330 that is associated with the graphical window 206 and a graph zoom control 332 that is associated with the graphical window 208. The graph zoom control 330 and graph zoom control 332 can operate in a manner substantially similar to the graph zoom control 328 described above.

In further embodiments, the graph zoom control 328, graph zoom control 330, graph zoom control 332, or combinations thereof can be associated with the event type control 202. Specifically, the graph zoom controls 328, 330, 332 can operate in a manner substantially equivalent to an input of a desired analysis, typically for displaying a single graphical window, via the event type control. For example, the graph zoom control 328 can invoke the breakfast comparison, the graph zoom control 330 can invoke the lunch comparison, and the graph zoom control 332 can invoke the dinner comparison.

Referring now to FIG. 10, the breakfast comparison analysis, which is an example of an enlarged view of an event, is schematically depicted. As is noted, the breakfast comparison analysis can be displayed automatically by one or more processors after input is received by event type control 202 or the graph zoom control 328 (FIG. 9). In the enlarged view, the graphical window 204 can take up the majority of the event analysis window 200. In some embodiments, the event analysis window 200 can comprise a previous view control 334 that is operable to change the information displayed in the event analysis window 200 to the previously displayed information. For example, if the graph zoom control 328 from the meal comparison analysis (FIG. 4) is utilized to invoke the breakfast analysis, upon receiving input via the previous view control 334, one or more processors can automatically invoke the meal comparison analysis.

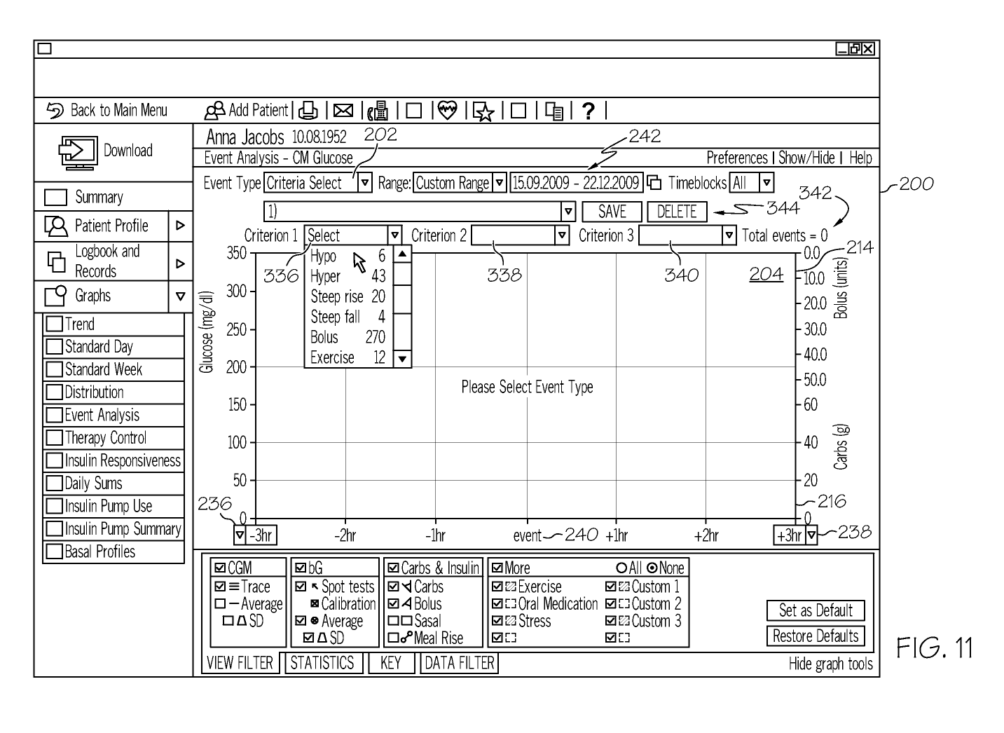

Referring collectively to FIGS. 7 and 11, the method 160 for visualizing correlations between biomarker data 70 and one or more events can optionally include process 182 for receiving criteria input. For example, when the criteria select analysis is input into the event type control 202, one or more controls that are configured to allow for the selection of criteria can be provided automatically by one or more processors, at process 182. Specifically, in one embodiment, a first level criterion control 336 can be provided to receive input indicative of an event class that groups event instances in classes based upon shared characteristics. In some embodiments, the first level criterion control 336 can provide a list of event classes for selection. For each event class, one or more processors can automatically analyze the biomarker data 70 to determine the number of event instances that are available in the range of dates input to the date range control 242. Accordingly, the number of event instances that are available for each event class can be provided visually within the first level criterion control 336.

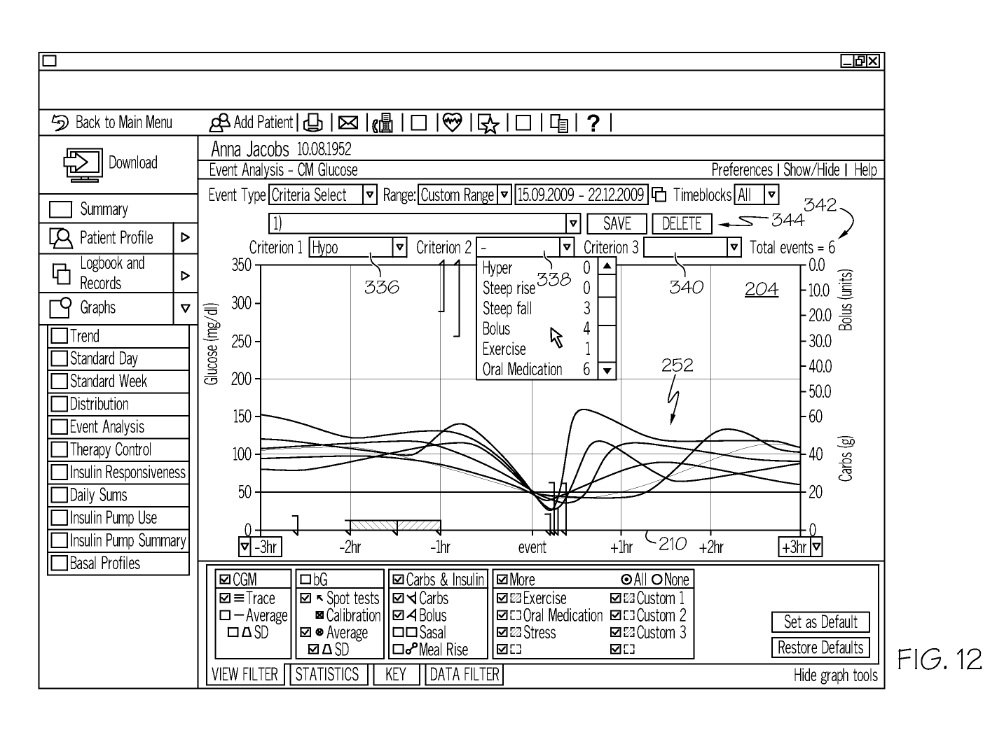

Referring collectively to FIGS. 7 and 12, upon input of the event class via the first level criterion control 336, a first subset of data can be generated from the biomarker data 70. Specifically, the first subset of data can be populated with CGM traces 252 that can be plotted within the graphical window 204. In one embodiment, the event instances associated with the event class from the first level criterion control 336 can be utilized with the range of dates to automatically provide the reference time 240, at process 166. For example, each event instance can be associated with an event time that is within the range of dates. The reference time 240 can be associated with each event time such that the relative time of the time abscissa axis 210 can be indexed to the actual time of the biomarker data 70. At process 168, the biomarker data 70 can be segmented into the first subset of data that is populated a segment of data for each event instance that includes an event time corresponding to the reference time 240 and an extent corresponding to the time range defined by the time abscissa axis 210 of the graphical window 204. In other words, the first subset of data can be populated by the CGM traces 252 that correspond to the selected class of events that occur during the range of dates. The CGM traces 252 can be plotted in the graphical window 204, as described above with respect to process 170 and process 172.

The event analysis window 200 can further comprise one or more additional controls for receiving criterion input. Accordingly, at process 184, one or more processors can automatically receive additional criterion input. In some embodiments, the event analysis window 200 can comprise a second level criterion control 338 for receiving input indicative of an event class that is available in the first subset of data. In some embodiments, the second level criterion control 338 can provide a list of event classes for selection from the first subset of data. The first subset of data can be analyzed automatically by one or more processors over the range of dates and the range of time that corresponds to the time range defined by the time abscissa axis 210 of the graphical window 204, i.e., after accounting for the differences between the relative time of the time abscissa axis 210 and the actual time of the biomarker data 70. Accordingly, the number of event instances in the first subset of data that occur within the time range of the range of dates defined by the time abscissa axis 210 can be counted. Optionally, the number of event instances that are available for each event class of the first subset of data can be provided visually within the second level criterion control 338.

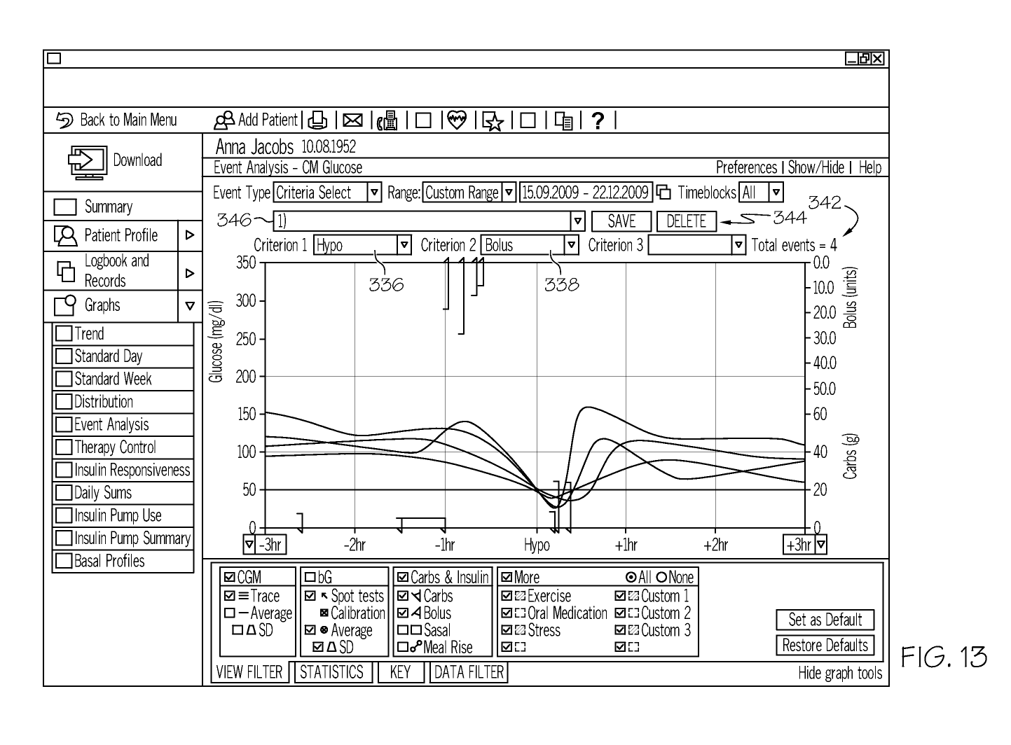

Referring now to FIG. 13, upon input of the event class via the second level criterion control 338, a second subset of data can be generated from the biomarker data 70. Specifically, the second subset of data can be populated with CGM traces 252 that include event instances associated with both the event class from the first level criterion control 336 and the event class the second level criterion control 338. The CGM traces 252 of the second subset of data can be plotted in the graphical window 204, as described above with respect to process 170 and process 172.

The event analysis window 200 can comprise a third level criterion control 340 for receiving input indicative of an event class that is available in the second subset of data. The third level criterion control 340 operates on the second subset of data in a manner substantially equivalent to the manner by which the second level criterion control 338 operates on the first subset of data. Accordingly, the third level criterion control 340 can be utilized to filter the second subset of data into a third subset of data based upon an input indicative of a desired event class of the second subset of data. The third subset of data can be populated by with CGM traces 252 that include event instances associated with all three of the event class from the first level criterion control 336, the event class from the second level criterion control 338, and the event class from the third level criterion control 340. The CGM traces 252 of the third subset of data can be plotted as described herein. It is noted that, while three controls for receiving criterion input are depicted in FIG. 13, the embodiments described herein can include any number of such controls. However, without being bound to theory, it is believe that three controls strikes the balance between inputs for filtering and filter complexity, i.e., less than three may not provide sufficient inputs and more than three may be too complex for use.

The event analysis window 200 can further comprise an event indication object 342 for providing a numerical count of the number of event instances that satisfy the criteria selection. Specifically, one or more processors can automatically determine the number of event instances that have been selected via the one or more controls for criterion input. For example, upon input of the event class via the first level criterion control 336, the event indication object 342 can provide the number of event instances within the first subset of data (FIG. 12). Similarly, upon input of the event class via the second level criterion control 338, the event indication object 342 can provide the number of event instances within the second subset of data (FIG. 13). Accordingly, the numerical count can be indicative of the number of CGM traces 252 that are plotted within the graphical window 204.

Referring still to FIG. 13, the event analysis window 200 can further comprise a pre-defined criteria control 344 that is configured to manage custom combinations of inputs from the one or more controls for criterion input. The pre-defined criteria control 344 can be associated with the first level criterion control 336, the second level criterion control 338 and the third level criterion control 340 to receive a custom combination. Additionally, pre-defined criteria control 344 can be operable to receive input that causes the one or more processors to save a custom combination. Specifically, upon the selection of event classes from one or more of the first level criterion control 336, the second level criterion control 338 and the third level criterion control 340, the combination and order of the event classes can be saved as a custom combination and associated with the pre-defined criteria control 344.

Additionally, the pre-defined criteria control 344 can be configured to automatically utilize a custom combination to obtain a subset of data. Specifically, the pre-defined criteria control 344 can be associated with one or more custom combinations. The pre-defined criteria control 344 can receive input indicative of a selected custom combination. The selected custom combination can be utilized by one or more processors to filter the biomarker data 70 into a desired subset of data. In one embodiment, pre-defined criteria control 344 can be associated with the first level criterion control 336, the second level criterion control 338 and the third level criterion control 340 to provide the selected custom combination. For example, upon receiving input indicative of the selected custom combination via the pre-defined criteria control 344, one or more processors can populate the first level criterion control 336, the second level criterion control 338 and the third level criterion control 340 such that the operation of the controls causes the desired subset of data to be plotted.

The pre-defined criteria control 344 can comprise a combo box 346 that is utilized to provide a list of one or more custom combinations and to receive input indicative of the selected custom combination. In one embodiment, the pre-defined criteria control 344 can be associated with the first level criterion control 336, the second level criterion control 338 and the third level criterion control 340 such that when input is provided to any of the criterion controls, the combo box 346 is cleared automatically by the one or more processors. In some embodiments, the pre-defined criteria control 344 can be configured to receive input indicative of a desire to delete a custom combination displayed in the combo box 346. For example, upon receiving input indicative of a desire to delete a custom combination displayed in the combo box 346, one or more processors can automatically disassociate the deleted custom combination from the pre-defined criteria control 344. Moreover, upon receiving input indicative of a desire to delete a custom combination displayed in the combo box 346, one or more processors can automatically clear the combo box 346.

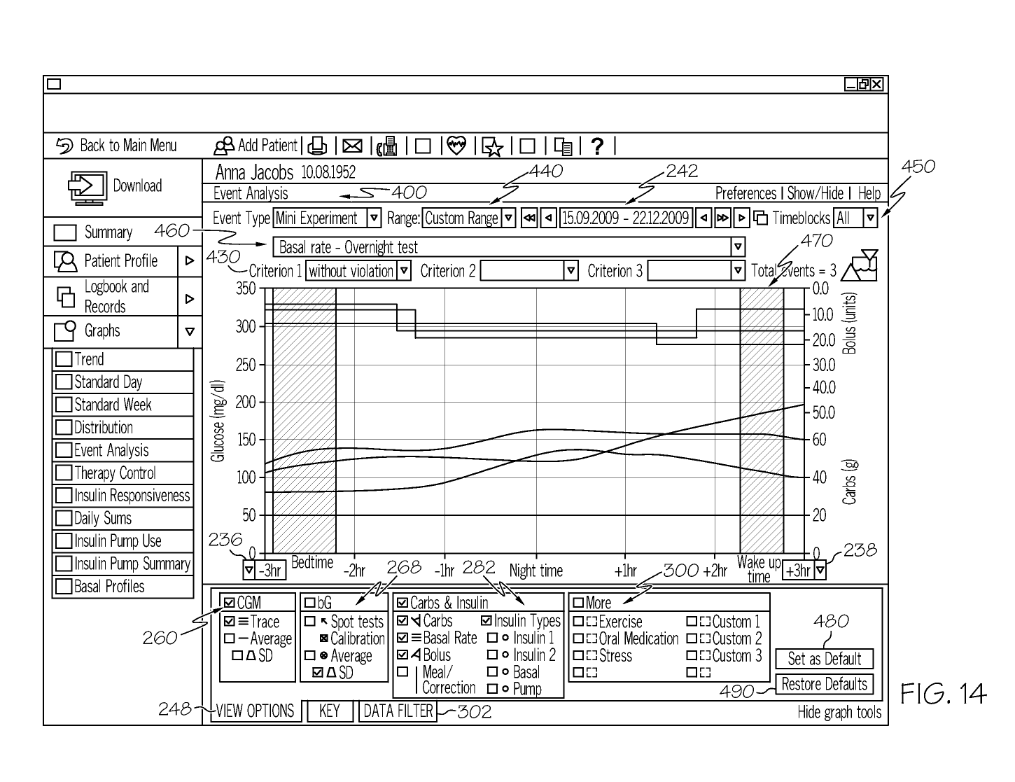

As mentioned previously above, reports can be generated using the stored patient data to help patients manage their physiological condition and support patient-doctor communications. For example, in one embodiment, the software 34 provides a dedicated graphical user interface for selecting a report type for the retrospective event analysis of mini experiments, i.e., the Mini-Experiment Event Analysis GUI 400, within a selected time range, such as shown in FIG. 14. The software 34 implements the handling of view filter options 248 and data filters 302 as well as the time range 242 as previously discussed above as well as time block selections (e.g., breakfast, lunch, and/or dinner) 450 and a report type selection 460. As illustrated, the software 34 displays a time range combo box 440 that can be used to designate, e.g., the following time ranges for a mini-experiment report: 3 days; 7 days; 2 weeks; 3 weeks; 1 month; 2 month; 3 month; and a custom range defined by the user. The software 34 also provides a number of criterion filters 430, e.g., for each mini-experiment report type 460 (selected, e.g., via a drop down box). For a Basal rate—Overnight test report (the illustrated selected report type in FIG. 14), a filter 430 can be selected to show results with violation and/or without violation; for the Basal rate—skipped meal test report (not shown), a filter 430 can be selected to show results with violation and/or without violation, and/or timeframe of the day (breakfast, lunch, dinner); and for the Preferred meal test report (not shown), a filter 430 can be selected to show results with violation and/or without violation, meal name, type of meal (breakfast, lunch, dinner), and/or starting glucose level. It is to be appreciated that for the selected report type 460, the selectable criterion filters 430 is automatically and dynamically change by the software 34 (i.e., by the one or more processors running the software 34).

It is to be appreciated that the Mini-Experiment Event Analysis GUI 400 can provide a number of report types which permits analysis of a data set in a specified time range and with selected applied filters. For example, in one embodiment and in the case of two basal rate tests as illustrated by FIG. 14, the depicted graph 470 shows an overlay of a basal rate with the lines of the basal rate in a corresponding color of a curve and without a filling area. In this embodiment, the graph 470 aligns in time at the main event of the respective selected Mini Experiment report type 460. The main event in this illustrated embodiment is the Basal rate—Overnight test report type which shows a night time measurement and highlights the time intervals of bed time and wake up measurements (i.e., for CGM the defined time intervals and for bG the time interval where the corresponding bG spot measurements have been performed), as shown by the grayed areas in FIG. 14. As depicted the x-axis shows 3 hours before and 3 hours after the Mini Experiment report type time period as default, but this time period is editable by the user as discussed above using drop-down boxes for the start time control 236 and an end time control 238. For example, each drop-down boxes for the time controls 236, 238 allows the change of the time scales of the x-axis in steps of one hour in both directions, such that maximum a full day becomes visible. Also, the depicted graph 470 shows the glucose level in a pre-defined unit on the y-axis. For example, if the number of data sets is not larger than seven, the graph 470 can show CGM curves and bG values of different days in different colors. Beyond seven days, the software 34 shall follow the rules specified previously above.

The Mini-Experiment Event analysis GUI 400 in addition to providing the view options 248, that allow the configuration of the currently visible graph 470 in the categories (i.e., the CGM view options 260, the bG view options 268 , the Carbs and Insulin view options 282) and following the handling as specified previously above, the software 34 provides in the GUI 400 the More category box 300 and the Data filter tab 302 as also specified previously above. It is to be appreciated that in all of the embodiments, for the selections made by the user via the user interface for each view and/or data filter option, such selections may be saved by the software 34 (i.e., automatically by the one or more processors to memory) as a default via selection of the Set as Default button 480 provided by any one of the GUIs of the software 34 depicted by FIGS. 4-6 and 9-14 Likewise, factory default settings of the software 34 may be set/reset upon selection of the Restore defaults button 490 also provided by the GUIs of the software 34 depicted by FIGS. 4-6 and 9-14.

Thus, by the above disclosure embodiments concerning a system and method managing the execution, data collection, and data analysis of collection procedures running simultaneously on a meter are disclosed. One skilled in the art will appreciate that the teachings can be practiced with embodiments other than those disclosed. The disclosed embodiments are presented for purposes of illustration and not limitation, and the invention is only limited by the claims that follow.

What is claimed is:

1. A computer-implemented method for visualizing correlations between blood glucose data and events, comprising:
presenting by one or more processors automatically an event analysis window on a display communicatively coupled to one or more processors, the event analysis window comprising an event type control positioned within the event analysis window and an graphical window positioned within the event analysis window, wherein the graphical window comprises a time abscissa axis that defines time units within the graphical window, a glucose ordinate axis that defines glucose units within the graphical window, and a bolus ordinate axis that defines bolus units within the graphical window;
receiving by the one or more processors event selection input via the event type control, wherein the event selection input is indicative of an event type associated with a plurality of event instances each being associated with an event time;
defining a reference time along the time abscissa axis of the graphical window;
segmenting by the one or more processors automatically a plurality of blood glucose values associated with a monitoring time period into a plurality of continuous glucose monitoring traces each indicative of blood glucose values, wherein each of the plurality of continuous glucose monitoring traces span a time segment of the monitoring time period such that the time segment is coincident with the event time of one of the plurality of event instances;
plotting by the one or more processors automatically the plurality of continuous glucose monitoring traces within the graphical window, wherein the plurality of continuous glucose monitoring traces are scaled according to the glucose ordinate axis and the time abscissa axis, and the time segment is normalized to and aligned with the reference time; and
presenting by the one or more processors automatically, within the event analysis window, a plurality of bolus icons each indicative of a bolus amount and a bolus time that is coincident with the monitoring time period of one of the plurality of continuous glucose monitoring traces, wherein each of plurality of bolus icons comprises a bolus indication object that is aligned with the bolus ordinate axis within the graphical window, a bolus time indication object that is aligned with the time abscissa axis within in the graphical window, and a bolus symbol that is presented outside of the graphical window.

2. The computer-implemented method of claim 1, further comprising:
presenting by the one or more processors automatically, within the event analysis window, a plurality of carbohydrate icons each indicative of a carbohydrate amount and a carbohydrate time that is coincident with the monitoring time period of one of the plurality of continuous glucose monitoring traces, wherein: the graphical window comprises a carbohydrate ordinate axis that defines carbohydrate units within the graphical window, and each of the plurality of carbohydrate icons comprises a carbohydrate indication object that is aligned with the carbohydrate ordinate axis within the graphical window, a carbohydrate time indication object that is aligned with the time abscissa axis within in the graphical window, and a carbohydrate symbol that is presented outside of the graphical window.

3. The computer-implemented method of claim 1, further comprising:
presenting a date range control by the one or more processors automatically within the event analysis window; and
receiving date input via the date range control by the one or more processors, wherein the date input is indicative of a plurality of dates and the event time of each of the plurality of event instances is coincident with at least one of the plurality of dates.

4. The computer-implemented method of claim 3, further comprising:
presenting one or more criterion controls within the event analysis window by the one or more processors automatically; and
receiving event class input via the one or more criterion controls by the one or more processors, wherein the event class input is indicative of multiple event classes and each of the plurality of event instances is grouped into one of the multiple event classes, and wherein each of the plurality of continuous glucose monitoring traces is coincident with the event time of one of the plurality of event instances for each of the multiple event classes.

5. The computer-implemented method of claim 4, further comprising:
presenting a numerical count of the continuous glucose monitoring traces within the event analysis window by the one or more processors automatically.

6. The computer-implemented method of claim 4, further comprising:
presenting a pre-defined criteria control within the event analysis window by the one or more processors automatically; and
associating the event class input with the pre-defined criteria control by the one or more processors automatically.

7. The computer-implemented method of claim 1, further comprising:
presenting an average trace control within the event analysis window by the one or more processors automatically, wherein the average trace control is configured to be selected and deselected; and
plotting an average trace within the graphical window by the one or more processors automatically, when the average trace control is selected, wherein the average trace is an average of the plurality of continuous glucose monitoring traces.

8. The computer-implemented method of claim 7, further comprising:
graying out the plurality of continuous glucose monitoring traces by the one or more processors automatically, when the average trace control is selected.

9. The computer-implemented method of claim 7, further comprising:
presenting a meal rise control by the one or more processors automatically, wherein the meal rise control is configured to be selected and deselected;
deactivating the meal rise control, when the average trace control is deselected, by the one or more processors automatically;
activating the meal rise control, when the average trace control is selected, by the one or more processors automatically; and
plotting a meal rise icon within the graphical window by the one or more processors automatically, when the meal rise control is activated and selected, wherein the meal rise icon is indicative of a postprandial change in blood glucose values of the average trace.

10. The computer-implemented method of claim 1, further comprising:
receiving input with one of the plurality of continuous glucose monitoring traces to identify the one of the plurality of continuous glucose monitoring traces as a selected trace by the one or more processors; and
highlighting the selected trace by the one or more processors automatically.

11. The computer-implemented method of claim 10, further comprising:
presenting a basal display control by the one or more processors automatically, wherein the basal display control is configured to be selected and deselected;
activating the basal display control, when the selected trace is highlighted, by the one or more processors automatically; and
plotting a basal graphical object within the graphical window by the one or more processors automatically, when a basal rate control is activated and selected, wherein the basal graphical object is scaled according to the time abscissa axis and the bolus ordinate axis such that the basal graphical object is indicative of a basal rate of insulin injected over time.

12. The computer-implemented method of claim 10, wherein the time segment and the bolus time are associated with a color code based upon date, and wherein each of the plurality of continuous glucose monitoring traces is displayed with the color code of the time segment, and the bolus indication object is displayed with the color code of the bolus time.

13. The computer-implemented method of claim 1, further comprising:
presenting by the one or more processors automatically one or more time controls for altering a start time, an end time, or both of the time abscissa axis of the graphical window;
receiving time input with the one or more time controls; and
updating by the one or more processors automatically the start time, the end time, or both of the time abscissa axis of the graphical window based upon the time input, wherein an extent of each of the plurality of continuous glucose monitoring traces is demarcated by the start time and the end time of the time abscissa axis.

14. The computer-implemented method of claim 1, further comprising:
presenting by the one or more processors automatically a reference range control within the event analysis window; and
receiving time range input via the reference range control, wherein the time range input is indicative of a time range, and wherein the event time of each of the plurality of event instances is coincident the time range.

15. A non-transitory computer readable medium storing a program causing one or more processors communicatively coupled to a display to execute a graphical user interface process for visualizing correlations between blood glucose data and events, the graphical user interface process comprising:
presenting by the one or more processors automatically an event analysis window on the display, the event analysis window comprising an event type control positioned within the event analysis window and an graphical window positioned within the event analysis window, wherein the graphical window comprises a time abscissa axis that defines time units within the graphical window, a glucose ordinate axis that defines glucose units within the graphical window, and a bolus ordinate axis that defines bolus units within the graphical window;
receiving by the one or more processors event selection input via the event type control, wherein the event selection input is indicative of an event type associated with a plurality of event instances each being associated with an event time;
defining a reference time along the time abscissa axis of the graphical window;
segmenting by the one or more processors automatically a plurality of blood glucose values associated with a monitoring time period into a plurality of continuous glucose monitoring traces each indicative of blood glucose values, wherein each of the plurality of continuous glucose monitoring traces span a time segment of the monitoring time period such that the time segment is coincident with the event time of one of the plurality of event instances;
plotting by the one or more processors automatically the plurality of continuous glucose monitoring traces within the graphical window, wherein the plurality of continuous glucose monitoring traces are scaled according to the glucose ordinate axis and the time abscissa axis, and the time segment is normalized to and aligned with the reference time; and
presenting by the one or more processors automatically, within the event analysis window, a plurality of bolus icons each indicative of a bolus amount and a bolus time that is coincident with the monitoring time period of one of the plurality of continuous glucose monitoring traces, wherein each of plurality of bolus icons comprises a bolus indication object that is aligned with the bolus ordinate axis within the graphical window, a bolus time indication object that is aligned with the time abscissa axis within in the graphical window, and a bolus symbol that is presented outside of the graphical window.

16. A medical device comprising a display and one or more processors communicatively coupled to the display and configured to:
present automatically an event analysis window on the display, the event analysis window comprising an event type control positioned within the event analysis window and an graphical window positioned within the event analysis window, wherein the graphical window comprises a time abscissa axis that defines time units within the graphical window, a glucose ordinate axis that defines glucose units within the graphical window, and a bolus ordinate axis that defines bolus units within the graphical window;
receive event selection input via the event type control, wherein the event selection input is indicative of an event type associated with a plurality of event instances each being associated with an event time;
define a reference time along the time abscissa axis of the graphical window;
segment automatically a plurality of blood glucose values associated with a monitoring time period into a plurality of continuous glucose monitoring traces each indicative of blood glucose values, wherein each of the plurality of continuous glucose monitoring traces span a time segment of the monitoring time period such that the time segment is coincident with the event time of one of the plurality of event instances;
plot automatically the plurality of continuous glucose monitoring traces within the graphical window, wherein the plurality of continuous glucose monitoring traces are scaled according to the glucose ordinate axis and the time abscissa axis, and the time segment is normalized to and aligned with the reference time; and
present automatically, within the event analysis window, a plurality of bolus icons each indicative of a bolus amount and a bolus time that is coincident with the monitoring time period of one of the plurality of continuous glucose monitoring traces, wherein each of plurality of bolus icons comprises a bolus indication object that is aligned with the bolus ordinate axis within the graphical window, a bolus time indication object that is aligned with the time abscissa axis within in the graphical window, and a bolus symbol that is presented outside of the graphical window.
